(19) United States
(12) Patent Application Publication
(10) Pub. No.: US 2025/0365746 A1
(43) Pub. Date: Nov. 27, 2025

(54) METHOD AND APPARATUS FOR SIDELINK COMMUNICATION

(71) Applicant: QUECTEL WIRELESS SOLUTIONS CO., LTD., Shanghai (CN)

(72) Inventors: Ling LYU, Shanghai (CN); Zheng ZHAO, Shanghai (CN)

(21) Appl. No.: 19/294,221

(22) Filed: Aug. 7, 2025

Related U.S. Application Data
(63) Continuation of application No. PCT/CN2023/135182, filed on Nov. 29, 2023.

(51) Int. Cl. H04W 72/25; H04W 16/14; H04W 72/0446

(52) U.S. Cl. CPC H04W 72/25; H04W 16/14; H04W 72/0446

(57) ABSTRACT

Disclosed are a method and apparatus for sidelink communication. The method is applicable to a first terminal device and includes: determining COT resources in shared spectrum, wherein the COT resources include PSFCH resources for transmitting PSFCHs; and assigning the PSFCH resources to a plurality of terminal devices sharing the COT resources based on a first set of PSFCHs to be transmitted, wherein the plurality of terminal devices include the first terminal device.

### CROSS-REFERENCE TO RELATED APPLICATIONS

This application is a continuation of International Application No. PCT/CN2023/135182, filed on Nov. 29, 2023, the disclosure of which is hereby incorporated by reference in its entirety.

### TECHNICAL FIELD

The present disclosure relates to the technical field of communications, and in particular, relates to a method and apparatus for sidelink communication.

### BACKGROUND

In sidelink communication on shared spectrum, a terminal device may determine channel occupancy time (COT) resources available for the sidelink communication using a mechanism such as Listen Before Talk (LBT). Within the COT resources, the terminal device typically configures a plurality of transmission opportunities for some critical channels, e.g., physical sidelink feedback channel (PSFCH) to improve transmission success rates.

However, the configuration of the plurality of transmission opportunities may lead to interruption of the COT resources, which adversely affects communication efficiency.

### SUMMARY

The present disclosure provides a method and apparatus for sidelink communication. Various aspects of embodiments of the present disclosure are described in detail hereinafter.

In a first aspect of the embodiments of the present disclosure, a method for sidelink communication is provided. The method is applicable to a first terminal device, and includes: determining COT resources in shared spectrum, wherein the COT resources include PSFCH resources for transmitting PSFCHs; and assigning the PSFCH resources to a plurality of terminal devices sharing the COT resources based on a first set of PSFCHs to be transmitted, wherein the plurality of terminal devices include the first terminal device.

In a second aspect of the embodiments of the present disclosure, a method for sidelink communication is provided. The method is applicable to a second terminal device, and includes: determining COT resources shared by a plurality of terminal devices, wherein the COT resources include PSFCH resources for transmitting PSFCHs, the plurality of terminal devices including a first terminal device and the second terminal device; and transmitting a PSFCH on a PSFCH resource assigned by the first terminal device to the second terminal device based on a first set of PSFCHs to be transmitted.

In a third aspect of the embodiments of the present disclosure, an apparatus for sidelink communication, wherein the apparatus is a first terminal device, and includes: a first determining unit, configured to determine COT resources in shared spectrum, wherein the COT resources include PSFCH resources for transmitting PSFCHs; and a second determining unit, configured to assign the PSFCH resources to a plurality of terminal devices sharing the COT resources based on a first set of PSFCHs to be transmitted, wherein the plurality of terminal devices include the first terminal device.

In a fourth aspect of the embodiments of the present disclosure, an apparatus for sidelink communication is provided. The apparatus is a second terminal device and includes: a determining unit, configured to determine COT resources shared by a plurality of terminal devices, wherein the COT resources include PSFCH resources for transmitting PSFCHs, the plurality of terminal devices including a first terminal device and the second terminal device; and a transmitting unit, configured to transmit a PSFCH on a PSFCH resource assigned by the first terminal device to the second terminal device based on a first set of PSFCHs to be transmitted.

In a fifth aspect of the embodiments of the present disclosure, a communication device is provided. The communication device includes a memory and a processor, wherein the memory is configured to store one or more programs, and the processor is configured to call the one or more programs stored in the memory to perform the method according to the first aspect or the second aspect.

In a six^{th} aspect of the embodiments of the present disclosure, a device is provided. The device includes a processor, wherein the processor is configured to call one or more programs from a memory to perform the method according to the first aspect or the second aspect.

In a seventh aspect of the embodiments of the present disclosure, a chip is provided. The chip includes a processor, wherein the processor is configured to call one or more programs from a memory to cause a device equipped with the chip to perform the method according to the first aspect and or second aspect.

In an eighth aspect of the embodiments of the present disclosure, a computer-readable storage medium storing one or more programs therein is provided, wherein the one or more programs, when loaded and run by a computer, cause the computer to perform the method according to the first aspect or the second aspect.

In a ninth aspect of the embodiments of the present disclosure, a computer program product is provided. The computer program product includes one or more programs, wherein the one or more programs, when loaded and run by a computer, cause the computer to perform the method according to the first aspect or the second aspect.

In a tenth aspect of the embodiments of the present disclosure, a computer program is provided. The computer program, when loaded and run by a computer, causes the computer to perform the method according to the first aspect or the second aspect.

In the embodiments of the present disclosure, subsequent to determining the COT resources in the shard spectrum, the first terminal device may assign the PSFCH resources to the plurality of terminal devices sharing the COT resources based on the first set of PSFCHs to be transmitted. Apparently, during assignment of the PSFCH resources in the COT resources, the corresponding PSFCHs to be transmitted have been determined. This is conducive to avoiding interruption of the COT resources due to the lack of transmission demands for the PSFCH resources, while improving resource utilization rate.

### BRIEF DESCRIPTION OF THE DRAWINGS

FIG. 1 is a wireless communication system according to some embodiments of the present disclosure;

FIG. 2 is an example communication diagram of NR-V2X;

FIG. 3 is a schematic diagram of transmitting a sidelink channel within a COT resource;

FIG. 4 is a schematic flowchart of a method for sidelink communication according to some embodiments of the present disclosure;

FIG. 5 is a schematic flowchart of an implementation of PSFCH resource sharing;

FIG. 6 is a schematic diagram of an implementation of a first bitmap;

FIG. 7 is a schematic block diagram of an apparatus for sidelink communication according to some embodiments of the present disclosure;

FIG. 8 is a schematic block diagram of an apparatus for sidelink communication according to some embodiments of the present disclosure; and

FIG. 9 is a schematic structural diagram of a communication apparatus according to some embodiments of the present disclosure.

### DETAILED DESCRIPTION

The technical solutions according to the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art without any creative efforts shall fall within the protection scope of the present disclosure.

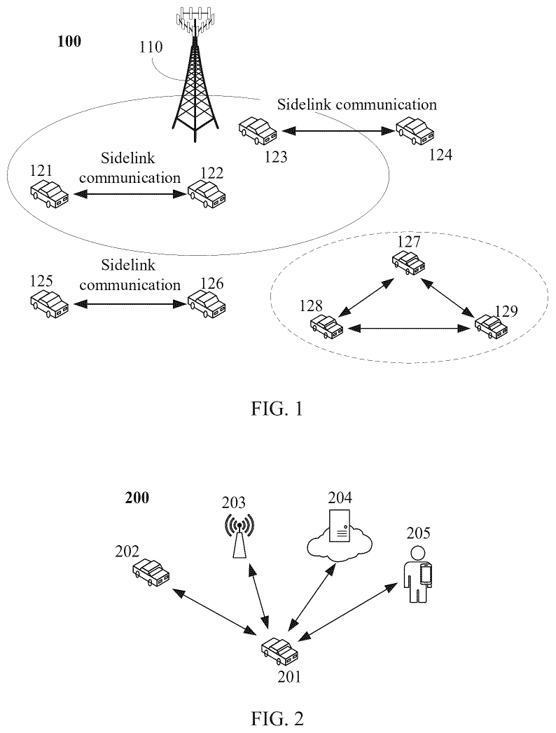

FIG. 1 is a system architecture diagram of a wireless communication system 100 applicable to embodiments of the present disclosure. The wireless communication system 100 includes a network device 110 and terminal devices 121 to 129. The network device 110 may provide communication coverage for a specific geographical region, and may communicate with any terminal within the coverage area.

In some implementations, the terminal devices may communicate with each other on a slidelink (SL). Sidelink communication may also referred to as proximity services (ProSe) communication, single-sided communication, side-channel communication, device-to-device (D2D) communication, or the like.

Alternatively, sidelink data may be transmitted on the slidelink between the terminal devices. The sidelink data may include data and/or control signaling. In some implementations, the sidelink data may be, for example, a physical sidelink control channel (PSCCH), a physical sidelink shared channel (PSSCH), PSCCH demodulation reference signal (DMRS), a PSFCH, or the like.

Hereinafter, several common sidelink communication scenarios are introduced with reference to FIG. 1. In sidelink communication, three scenarios may be involved depending on whether the terminal devices in the sidelink are within the coverage range of the network device. Scenario 1: The terminal devices are in sidelink communication with each other within the coverage range of the network device. Scenario 2: some of the terminal devices are in sidelink communication with each other within the coverage range of the network device. Scenario 3: The terminal devices are in sidelink communication with each other outside the coverage range of the network device.

As illustrated in FIG. 1, in scenario 1, the terminal devices 121 and 122 may be in communication with each other on the sidelink, and the terminal devices 121 and 122 are both within the coverage area of the network device 110, or the terminal devices 121 and 122 are both within the coverage area of the same network device 110. In this scenario, the network device 110 may transmit a configuration signaling to the network devices 121 and 122, and correspondingly, the terminal devices 121 and 122 carry out communication on the sidelink based on the configuration signaling.

As illustrated in FIG. 1, in scenario 2, the terminal devices 123 and 124 may be in communication with each other on the sidelink, and the terminal device 123 is both within the coverage area of the network device 110 and the terminal device 124 is outside the coverage area of the network device 110. In this scenario, the terminal device 123 receives configuration information of the network device 110, and carries out communication on the sidelink based on configuration of the configuration signaling. However, with respect to the terminal device 124, since the terminal device 124 is outside the coverage area of the network device 110, the terminal device 124 fails to receive the configuration information of the network device 110. In this case, the terminal device 124 may acquire configuration of sidelink communication based on pre-configuration information and/or the configuration information sent by the terminal device 123 within the coverage area, and hence communicate with the terminal device 123 on the sidelink based on the acquired configuration.

In some cases, the terminal device 123 may transmit the configuration information to the terminal device 124 on a physical sidelink broadcast channel (PSBCH), such that the terminal device 124 carries out communication on the sidelink.

As illustrated in FIG. 1, in scenario 3, the terminals 125 to 129 all outside the coverage area of the network device 110, and thus fail to communicate with the network device 110. In this case, the terminal devices may all carry out sidelink communication based on the pre-configuration information.

In some cases, the terminal devices 127 to 129 outside the coverage area of the network device may constitute a communication group, and the terminal devices 127 to 129 within the communication group may communicate with each other. In addition, the terminal device 127 within the communication group may serve as a central control node, which is also referred to as a cluster header (CH) terminal, and the other terminal devices within the communication group may also be referred to as “cluster members” (or group members).

The terminal device 127 as the CH terminal may implement one or more of the following functions: establishing the communication group; granting join and leave of group members; coordinating and managing resources to assign sidelink transmission resources to the group members and receive sidelink feedback information of the group members; and coordinating resources with other communication groups, and the like.

It should be noted that FIG. 1 exemplarily illustrates one network device and a plurality of terminal devices. Optionally, the wireless communication system 100 may include a plurality of network devices and each of the network devices provide a coverage area for another numbers of terminal devices, which is not limited in the embodiments of the present disclosure.

Optionally, the wireless communication system 100 may further include another network entity such as a network controller, a mobility management entity, or the like, which is not limited in the embodiments of the present disclosure.

It should be understood that the technical solutions according to the embodiments of the present disclosure may be applied to various communication systems, for example: a 5th generation (5G) or a new radio (NR) system, a long-term evolution (LTE) system, an LTE frequency-division duplex (FDD) system, an LTE time-division duplex (TDD) system, or the like. The technical solutions according to the present disclosure may also be applied to future communication systems, such as a 6th generation (6G) mobile communication system, such as a satellite communication system or the like.

The terminal device according to the embodiments of the present disclosure may also be referred to as a user equipment (UE), an access terminal, a subscriber unit, a subscriber station, a mobile station (MS), a mobile terminal (MT), a remote station, a remote terminal, a mobile device, a user terminal, a wireless communication device, a user agent, or a user apparatus. The terminal device according to the embodiments of the present disclosure may refer to a device providing voice and data connectivity for users, or device capable of connecting to human, things, and machines, for example, a handheld device, a vehicle-mounted device or the like having a wireless connection function. The terminal device according to the embodiments of the present disclosure may be a mobile phone, a ad, a laptop, a palmtop, a mobile Internet device (MID), a wearable device, a vehicle, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. Optionally, the terminal device may serve as a base station. For example, the terminal device may serve as a dispatch entity, which provides sidelink signals between terminal devices in vehicle-to-everything (V2X) or D2D or the like. For example, a cellular phone and a vehicle communicate with each other based on the sidelink data. The cellular phone and a smart home device communicate with each other, with no need of relaying communication signals over a base station.

The network device according to the embodiments of the present disclosure may be a device for communicating with the terminal device. The network device may also be referred to as an access network device or a wireless access device. For example, the network device may be a base station. The network device according to the embodiments of the present disclosures may refer to a radio access network (RAN) node (or device) that accesses a terminal device to a wireless network. The base station may broadly cover or replace various names such as, a node B (NodeB), an evolved base station (evolved NodeB, eNB), a next generation base station (next generation NodeB, gNB), a relay station, a transmitting and receiving point (TRP), a transmitting point (TP), an access point (AP), a primary station MeNB, and a secondary station SeNB, an multi-standard radio (MSR) node, a home base station, a network controller, an access node, a wireless node, a transmission node, a transceiver node, a baseband unit (BBU), a remote ratio unit (RRU), an active antenna unit (AAU), a remote radio head (RRH), and a central unit (CU), a distributed unit (DU), a location node, and the like. The base station may be a macro base station, a micro base station, a relay node, a donor node, or the like, or a combination thereof. The base station may also refer to a communication module, a modem, or a chip configured in the above apparatus or device. The base station may also be a mobile switching center and a device in D2D, V2X, or machine-to-machine (M2M) communication to assume the function of a base station, a network-side device in a 6G network, a device in a future communication system to assume the function of a base station, or the like. The base station may support networks of the same or different access technologies. The embodiments of the present disclosure do not limit the specific technology adopted by a network device and the specific device form.

The base station may be stationary or mobile. For example, a helicopter or unmanned aerial vehicle may be configured to serve as a mobile base station, and one or more cells may move depending on the location of the mobile base station. In other examples, the helicopter or unmanned aerial vehicle may be configured to serve as a device to communicate with another base station.

In some deployments, the network device according to the embodiments of the present disclosure may refer to a CU or a DU, or the network device includes a CU and a DU. The gNB may also include an AAU.

The network device and the terminal devices may be deployed on land, including indoor or outdoor, hand-held, or vehicle-mounted; or may be deployed on the water surface; or may be deployed on airplanes, balloons, and satellites. In the embodiments of the present disclosure, the scenario where the network device and the terminal devices are located is not limited.

It will be appreciated that all or part of the functionality of the communication devices in the present disclosure may also be implemented by software functions running on hardware, or by virtualization functions instantiated on a platform, such as a cloud platform.

For ease of understanding, some related technical knowledge involved in the embodiments of the present disclosure is described hereinafter. The following related technologies, as optional solutions, may be randomly combined with the technical solutions according to the embodiments of the present disclosure, which all fall within the protection scope of the embodiments of the present disclosure. The embodiments of the present disclosure may include at least part of the following content.

### Communication Mode on Sidelink

With the development of the sidelink communication technology, the sidelink communication technology involves information interactions between a variety of types of terminal devices. Using a V2X communication system 200 as illustrated in FIG. 2 as an example, vehicle-to-vehicle (V2V) communication carried out between a terminal device 201 and a terminal device 202 involves information interactions between vehicles. Vehicle-to-infrastructure (V2I) communications, vehicle-to-network (V2N) communications, and vehicle-to-pedestrian (V2P) communications carried out between the terminal device 201 and terminal devices 203 to 205 involve information interactions between a vehicle and an external system.

With gradual expansion of the information interactions, some higher and stricter requirements are imposed to the communication system. Using the development of V2X as an example, in LTE-V2X, sidelink communication in a broadcast mode is only supported between the terminal devices. In NR-V2X, three communication modes, including broadcast, multicast, and unicast are supported.

The broadcast is a most basic communication mode in sidelink communication. With respect to a broadcast transmission mode, the terminal device receiving sidelink data may be any terminal device in the vicinity of the terminal device serving as a transmitter end. For example, referring to FIG. 1, assuming that the terminal device 125 serves as a transmitter end and transmits sidelink data in a broadcast mode, the terminal devices 121 to 124 and 126 to 129 in the vicinity of the terminal device 125 may all serve a receiver end of the sidelink data.

Multicast communication is configured to support information interactions between terminal devices within a specific group (or referred to as a communication group), to help to implement negotiation and decision making or the like between the terminal devices in the group. A communication group that performs multicast communication may be either a managed group with a stable connection relationship or a connectionless group formed in a connectionless manner.

With respect to a multicast transmission mode, the terminal devices receiving the sidelink data may be all the terminal devices in a communication group. Alternatively, the terminal devices receiving the sidelink data may be all the terminal devices within a specific transmission distance. For example, referring to FIG. 1, for a communication group including the terminal devices 127 to 129, when the terminal device 127 transmits sidelink data in a multicast mode, the other terminal devices 128 and 129 in the communication group are receiver terminals that receive the sidelink data. As another example, referring to FIG. 1, assuming that the terminal devices within a predetermined range include the terminal devices 127 to 129, and when the terminal device 127 transmits sidelink data in a multicast mode, the other terminal devices 128 and 129 within the predetermined range are all receiver terminals that receive the sidelink data.

Unicast communication implements sidelink communication between two terminal devices. Using NR-V2X as an example, radio resource control (RRC) signalings based on a PC5 interface implement reliable terminal-to-terminal communication.

With respect a unicast transmission mode, there is typically only one terminal device that receives sidelink data. Referring to FIG. 1, the terminal device 121 and the terminal device 122 may communicate with each other based on the unicast transmission mode. For example, when the terminal device 121 is in sidelink communication with terminal device 122, the terminal device 122 receives sidelink data as the only receiver device. The sidelink data may include a PSSCH and a PSCCH. By demodulation, the terminal device 122 may acquire sidelink control information (SCI) related to sidelink transmission and scheduling. The SCI may assist the terminal device 122 in receiving and decoding sidelink information.

In some communication systems, sidelink supports a hybrid automatic repeat request (HARQ) mechanism through an acknowledgement (ACK)/negative acknowledgement (NACK) information. By way of example, HARQ feedback of a sidelink channel may be transmitted, on a PSFCH, by a terminal device receiving a channel to a terminal device transmitting a channel.

In a system supporting the HARQ mechanism, a plurality of formats of 2^{nd}-stage SCI transmitted on a PSSCH may be used for PSSCH decoding under different scenarios. By way of example, when the HARQ-ACK information includes either ACK or NACK, SCI format 2-A is used for PSSCH decoding. Where the HARQ-ACK information includes only NACK or where there is no HARQ-ACK message feedback, the terminal device performs HARQ operations. By way of example, when HARQ operations are performed and the HARQ-ACK information includes only NACK or there is no HARQ-ACK message feedback, SCI format 2-B is used for PSSCH decoding. By way of example, SCI format 2-C may only be used for PSSCH decoding in unicast communication. Further, SCI format 2-C may also provide coordination information between terminal devices or request coordination messages between terminal devices.

A plurality of formats of the second-stage SCI may be indicated by a value of a 2^{nd}-stage SCI format field, as specified in Table 1.

TABLE 1

| Value of 2^{nd}-stage SCI format field | 2^{nd}-stage SCI format) |
|---|---|
| (value of 2^{nd}-stage SCI format field) | (2^{nd}-stage SCI format) |
| 00 | SCI format 2-A |
| 01 | SCI format 2-B |
| 10 | SCI format 2-C |
| 11 | Reserved |

### Communication Spectrum of Sidelink

The spectrum used by communication systems includes licensed spectrum (licensed frequency bands) and unlicensed spectrum (unlicensed frequency bands). An important direction for the expansion of communication systems into different domains is the use of unlicensed spectrum. For example, NR deployed in the unlicensed spectrum is referred to as NR-U.

Currently, sidelink primarily utilizes licensed spectrum. However, sidelink may also operate in the unlicensed spectrum. Sidelink deployed in the unlicensed spectrum may be referred to as SL-U.

Compared to licensed spectrum, unlicensed spectrum has feature of being shared without the need for licensing, and is therefore also referred to as shared spectrum. For network operators, spectrum sharing facilitates timely spectrum aggregation to dynamically support high-bandwidth services. Spectrum sharing may also extend the benefits of communication technologies (e.g., NR) to operational entities that may not have access to licensed spectrum.

Shared spectrum requires consideration of coexistence between different radio access technology (RAT) systems, such as wireless fidelity (Wi-Fi) systems and LTE-based license-assisted access (LAA) systems, as typical examples. Different systems use frequency bands in unlicensed spectrum in a contention manner, following principles of channel access fairness and multi-RAT coexistence.

In shared spectrum, any RAT system needs to carry out communication under the constraints of unlicensed spectrum regulatory rules. These regulatory rules include power and power spectral density levels, maximum COT, channel occupancy bandwidth, a channel monitoring mechanism, and other relevant parameters. In the same frequency band, each system needs to comply with regulatory rules, appropriately occupying and releasing channels to avoid interference with other RAT systems in the same frequency band.

To achieve multi-RAT coexistence, mandatory monitoring techniques (e.g., LBT) are employed when using shared spectrum. Devices in the RAT system may only transmit data when the devices detect that the current channel is not occupied, thereby ensuring that a shared channel is clear and ready for use before transmission. For example, a terminal device in sidelink communication may perform LBT to determine whether the shared channel is unoccupied. The terminal device may transmit signals on the shared channel only in a case where the LBT is successful.

The terminal device may initiate different types of LBT. LBT types include, for example, Type 1, Type 2A, Type 2B, and Type 2C, any of which may be used. Different LBT types are defined with corresponding monitoring durations to satisfy the requirements for initial channel occupation and channel occupation after a gap duration.

By way of example, the terminal device may initiate Type 1 LBT for initial channel access on shared spectrum.

By way of example, in the gap between two transmissions, the terminal device may initiate Type 2A LBT or Type 2B LBT. In Type 2A LBT or Type 2B LBT, whether the channel resources are occupied may be determined based on channel detection over a specific period.

By way of example, in a case where the gap between two transmissions is less than 16 μs, the terminal device may initiate Type 2C LBT. In Type 2C LBT, data transmission may be directly performed without performing channel detection.

In SL-U, the terminal device uses LBT to acquire resources shared with other terminal devices, which may also be referred to as COT resources. Subsequent to acquisition of the COT resources, the terminal device may perform the corresponding detection and data transmission preparation, and then transmit data based on the regulatory rules. For example, during transmission of data on channel resources, the terminal device needs to comply with the constraints of the COT resources. That is, a continuous data transmission needs to be limited to a COT time; and where the transmission exceeds the COT time, the terminal device needs to release the channel and perform LBT again.

However, channel access mechanisms such as LBT involve uncertainty. For channel access operations in the shared spectrum, where the channel access process fails (i.e., LBT failure), transmission of the terminal device may be interrupted. In addition, where only LBT is performed in SL-U, it may be difficult for the terminal device to predict potential interference in the system, and conflicts resulting from LBT failures may also increase.

Therefore, for high-priority channel/signal transmissions, SL-U needs to consider corresponding mechanisms to improve the transmission success rate. By way of example, in the case of a current LBT failure, additional transmission and/or flexible association of a transmission opportunity may be allowed at a later transmission opportunity.

As an example, high-priority channel/signal transmissions may include the transmission of a PSFCH. PSFCH may carry HARQ feedback for a PSSCH or a PSCCH. The absence of HARQ feedback may significantly affect system performance.

In sidelink communication, the resources used for transmitting the PSFCH include both public and dedicated (private) resources. Different types of PSFCHs may be configured to occupy different PSFCH resources. By way of example, for Type 1 PSFCH (sl-PSFCH-Type=′type1′), the PSFCH resources consist solely of X dedicated resources. The terminal device may evenly assign power across all physical resource blocks (PRBs) in interlace used for PSFCH transmission. For Type 2 PSFCH (sl-PSFCH-Type=′type2′), the PSFCH resources include one public resource and X dedicated resources. The terminal device may assign power to PRBs used for PSFCH transmission. The power assignment method differs between the public and dedicated resources.

The resources used for transmitting the PSFCH may also be referred to as the transmission opportunities for the PSFCH. In the associated sidelink communication, the transmission opportunities for the PSFCH may periodically appear in the time domain within the resource pool, and have a (pre-) configured period. For example, the predefined periodicity of the PSFCH resources may have values in the range of {1, 2, 4} slots.

The transmission opportunity for PSFCH may consist of one or more resource blocks (RBs) from an available set of RBs. As mentioned above, the PSFCH may be used to carry HARQ feedback for other channels. For example, the PSSCH is transmitted on sub-channels in a resource pool and slots in a time domain. The SL may map a PSSCH to a PSFCH transmission opportunity. This transmission opportunity is used to transmit the PSFCH related to the PSSCH.

Furthermore, in a case where a PSSCH transmission is associated with a single PSFCH transmission opportunity, where the channel access process fails before this single transmission opportunity, the HARQ-ACK feedback associated with the PSSCH may be discarded because the HARQ-ACK feedback fails to be transmitted. To mitigate the impact of a channel access failure, SL may support a more flexible PSFCH transmission opportunity mapping mechanism. By way of example, a PSSCH transmission may allow a plurality of transmission opportunities for an associated PSFCH. The terminal device may flexibly select, based on a successful channel access process, one of the plurality of the transmission opportunities to transmit the PSFCH.

However, the configuration of the plurality of PSFCH transmission opportunities may increase the probability of interruption of the COT resources. In the case of interruption of the COT resources, the plurality of terminal devices sharing the COT resources may fail to operate properly. Therefore, avoiding interruption of the COT resources is a critical technical issue that needs to be addressed.

Moreover, the COT resources need to reserve a plurality of PSFCH resources corresponding to the PSFCH transmission opportunities. However, not all of these PSFCH resources may be used for transmitting the PSFCH. Therefore, improving the utilization efficiency of PSFCH resources and maximizing the use of PSFCH resources is also a technical issue that needs to be considered.

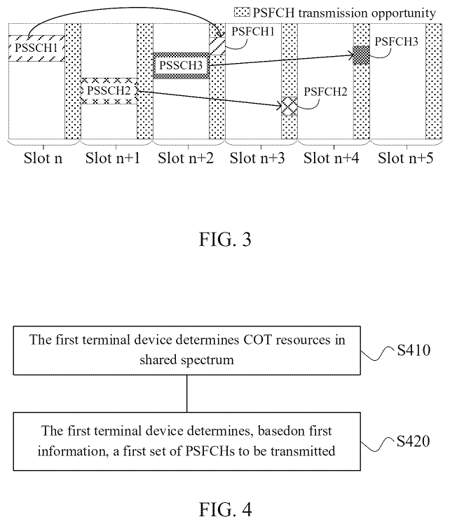

For better understanding, the issue of interruption of the COT resources is illustratively explained using multi-consecutive slot transmission (MCSt), as illustrated in FIG. 3. The COT resources in FIG. 3 include six slots, ranging from slot n to slot n+5. As illustrated in FIG. 3, six slots are configured with six PSFCH transmission opportunities to ensure the transmission of the PSFCH.

Referring to FIG. 3, the terminal device transmits three PSSCHs, that is, a PSSCH 1, a PSSCH 2, and a PSSCH 3, using some of the slots in the COT resources for the MCSt. The three PSSCHs are each associated with three PSFCHs. The PSSCH 1 is transmitted in slot n, and the associated PSFCH 1 is transmitted in slot n+2. The PSSCH 2 is transmitted in slot n+1, and the associated PSFCH 2 is transmitted in slot n+3. The PSSCH 3 is transmitted in slot n+2, and the associated PSFCH 3 is transmitted in slot n+4.

As shown in FIG. 3, no PSFCH needs to be transmitted in slot n and slot n+1. Therefore, the two PSFCH transmission opportunities in slot n and slot n+1 may result in non-continuous transmission between the three PSSCHs. Since an interval between the three PSSCH transmissions may exceed 25 μs, other terminal devices may perform Type 1 LBT for channel access. In this scenario, interruption may be caused to the COT resources in FIG. 3, such that the MCSt fails to operate properly.

As illustrated in FIG. 3, the configuration of the plurality of PSFCH transmission opportunities may increase the probability of interruption of the COT resources. However, the motivation for introducing the plurality of PSFCH transmission opportunities is to avoid the impact of an LBT failure and to improve system performance. Therefore, the issue of how to avoid interruption of the COT resources and improve resource utilization rate while ensuring system performance needs to be addressed.

It should be noted that the issue of interruption of the COT resources and low PSFCH resource utilization rate due to the configuration of PSFCH transmission opportunities, as mentioned above, is merely an example. The embodiments of the present disclosure may be applied to any scenario in shared spectrum where interruption of the COT resources or low transmission resource utilization rate occurs due to the configuration of transmission resources.

Accordingly, some embodiments of the present disclosure provide a method for sidelink communication. By this method, subsequent to determining COT resources in shared spectrum, a first terminal may assign, based on the COT resources, corresponding PSFCH resources for part or all PSFCHs that need to be transmitted by a plurality of terminal devices. This helps to improve the utilization rate of the PSFCH resources, and is thus conducive to avoiding interruption of the COT resources. The method for sidelink communication according to the embodiments of the present disclosure is described hereinafter with reference to FIG. 4.

Referring to FIG. 4, in step S410, the first terminal device determines COT resources in shared spectrum.

The first terminal device is a device engaged in sidelink communication. By way of example, the first terminal device may be a device that needs to transmit data in sidelink communication. By way of example, the first terminal device may be a terminal in a sidelink.

The first terminal device may perform unicast communication, multicast communication, or broadcast communication with other terminal devices. In some embodiments, the first terminal device performing channel monitoring may be a group head terminal that initiates multicast communication or broadcast communication, or may be a group member terminal in multicast communication or broadcast communication. For example, in V2X, the first terminal device may be a vehicle performing multicast communication with other vehicles, or may be another vehicle in the multicast communication.

In some embodiments, the first terminal device may be located within the network coverage area. The first terminal device may acquire channel resources on the shared spectrum based on configuration of a network device.

In some embodiments, the first terminal device may be located outside the network coverage area. The first terminal device may acquire channel resources on the shared spectrum based on pre-configuration of the network device.

The channel resources acquired by the first terminal device may be represented by COT, and therefore referred to as COT resources. For example, the first terminal device may determine start and end times of the channel resources on the shared spectrum, and hence determine the COT resources.

In some embodiments, the COT resources may include both public and dedicated (private) resources. For example, the COT resources may include dedicated resources for the first terminal device, and public resources shared by a plurality of terminal devices.

The first terminal device may be an initiator terminal for the COT resources. The COT resources determined by the first terminal device on the shared spectrum may be shared with other communication devices. Other communication devices may include other terminal devices. In other words, the first terminal device may initiate COT sharing with other terminal devices on the shared spectrum. For example, in V2X, the first terminal device may provide COT resources to nearby vehicles or other sidelink communication devices.

The first terminal device determines COT resources on the shared spectrum in order to acquire channel resources that may be used for sidelink communication. The sidelink communication includes PSFCH transmission. Therefore, the COT resources include PSFCH resources used for transmitting PSFCHs.

In some embodiments, PSFCHs may be used to transmit HARQ-ACK information related to the PSSCH transmission. By way of example, the HARQ-ACK information may include ACK or NACK, or may include only NACK.

In some embodiments, the PSFCHs may also be used to transmit coordination information or feedback related to coordination between terminal devices (e.g., inter-UE coordination). In other words, the PSFCHs may carry coordination information for sidelink communication. As an example, in a scenario of sidelink communication between the first terminal device and the second terminal device, when the first terminal device transmits resource coordination information to the second terminal device, the second terminal device may transmit feedback information related to the resource coordination information to the first terminal device on the PSFCHs.

As an example, the resource coordination information may be resource coordination signaling. This signaling may indicate an expected or potential resource conflict of reserved resources. Reserved resources may be any resources reserved for sidelink communication within the COT resources.

As an example, the resource coordination information may also be transmitted by the second terminal device to the first terminal device. In other words, the plurality of terminal devices supporting inter-UE coordination may all transmit the resource coordination information or the feedback information.

As an example, the feedback information related to the resource coordination information may also be carried in the SCI.

As an example, where the plurality of terminal devices support the coordination signaling, the first terminal device that initiates COT sharing may transmit the resource coordination signaling or the coordination information to other terminal devices to indicate the expected or potential resource conflict of reserved resources. To avoid the resource conflict, the second terminal device receiving the information may carry the feedback information related to the resource conflict in the SCI or PSFCH feedback transmitted to the first terminal device.

For example, the terminal device may determine a set of resources of one or more reserved slots and resource blocks for PSSCH transmission based on the indication in the SCI format. In this scenario, where the terminal device determines that there is a conflict in the reserved resources for the PSSCH transmission, the terminal device may provide conflict information in the PSFCH/SCI.

The first terminal device may indicate the PSFCH transmission in various ways. As an example, the first terminal device may indicate how to transmit a PSFCH based on the SCI format for PSSCH reception. As another example, the first terminal device may provide PSFCH resources through the sidelink PSFCH period. Additionally, the PSFCH transmission may also be indicated by higher layers. For example, higher layers may instruct the receiving terminal not to transmit a PSFCH including HARQ-ACK information in response to the PSSCH reception.

As one implementation, the terminal device receiving the SCI may receive PSSCHs according to the SCI format and send PSFCHs with HARQ-ACK information in response to the PSSCH reception.

For example, when a terminal device receives PSSCHs in the resource pool, the indication information of the associated SCI format may be determined. The relevant value of the indicator field related to HARQ feedback enable/disable in formats 2-A/2-B/2-C serves as this indication information. The terminal device may provide the corresponding HARQ-ACK information for the PSFCH transmission in the resource pool based on this information.

As an implementation approach, the parameter sl-PSFCH-Period may indicate the resource period of the PSFCH transmission opportunities reserved for the plurality of terminal devices in the resource pool. This resource period may span a plurality of slots. Where the value of sl-PSFCH-Period is 0, it indicates that the PSFCH transmission of terminal devices in the resource pool is disabled.

In some embodiments, the SCI or higher layer may indicate the PSFCH resources within the COT resources.

The PSFCH resources may be used for transmitting PSFCHs of Type 1 or Type 2, which is not limited herein. As described above, different types of PSFCHs are allocated different PSFCH resources.

The PSFCH resources may include common resources and dedicated resources to satisfy the transmission requirements of different types of PSFCHs.

As an example, the PSFCH resources may include a plurality of consecutive resources or a plurality of spaced-apart resources.

The PSFCH resources may be time-domain and/or frequency-domain resources within the COT resource pool. By way of example, the PSFCH resources may include one or more available PRBs, and thus, the PSFCH resources may form a set of PRBs.

In some embodiments, the PSFCH resources may include a plurality of PSFCH occasions. The PSFCH occasions may also be referred to as PSFCH transmission occasions or PSFCH instances. As an example, the plurality of PSFCH occasions within the COT resources may be represented by

$${N}_{occasion}^{PSFCH}$$

occasions. These

$${N}_{occasion}^{PSFCH}$$

occasions may be located in a plurality of slots, which are associated with the PSFCH resources. For example, the terminal device may transmit PSFCHs on the

$${N}_{occasion}^{PSFCH}$$

occasions within the plurality of slots.

In some embodiments, a PSCCH/PSSCH transmission may have Q associated PSFCH occasions. For any given PSCCH/PSSCH transmission, the Q associated PSFCH occasions are supported to be located in different slots within the same set of RBs. By way of example, the slot (e.g., slot a) where the first PSFCH occasion of the PSCCH/PSSCH transmission is located corresponds to the 1^{st} PSFCH. In a case where 1≤q≤Q, a q^{th} PSFCH occasion is located in slot a+(q−1)×P, wherein P is equal to a (pre-) configured PSFCH period. The value of P may be given by the parameter sl-PSFCH-Period.

As an example, the parameter sl-PSFCH-Period may also provide additional parameters

$${N}_{PSSCH}^{PSFCH}$$

for determining the PSFCH transmission occasions. For instance, where

$$k mod {N}_{PSSCH}^{PSFCH} = 0 ,$$

PSFCH transmission occasion resources are available are available in the slot associated with k(0≤k<Tₘₐₓ). Tₘₐₓ represents the total number of slots within the COT resources.

In some embodiments, the PRBs (pre-)configured for the PSFCH transmission within a set of RBs are organized into N identical or different subsets of PRBs, wherein N is a positive integer. These subsets of PRBs may be represented by indices. sFor example, these subsets of PRBs may be denoted as PRB #1, PRB #2, . . . , PRB #N. The subsets of PRBs or their indices may be associated with N candidate PSFCH occasions, which will be further described in conjunction with bitmap indication.

As an example, in SL-U, when a subcarrier spacing (SCS) is 15 kHz, a maximum number of PRBs in a set of RBs is 100. Therefore, the value range of a set of sidelink PSFCH RBs may be pre-configured as {10, . . . , 100}. For flexibility, each set of RBs needs to be pre-configured with N different subsets of PRBs. Additionally, it is necessary to determine all interleaved PRBs within the resource pool that are used for PSFCH transmission to carry HARQ-ACK information.

As an example, different subsets of PRBs may be represented by indices of different resource subsets. For the scenario of shared spectrum channel access, when sl-PSFCH-Type=′type1′, and within a set k of RBs, the terminal device may indicate, based on a plurality of sets of sidelink PSFCH RBs, a set of PRBs for a specific PSFCH occasion used for PSFCH transmission or PSCCH/PSSCH transmission.

For an n^{th} PSFCH transmission occasion, in a case where

$$1 \leq n \leq {N}_{occasion}^{PSFCH} ,$$

the terminal device may determine a plurality of interlace sets based on the PRBs from a plurality of sets of sidelink PSFCH RBs. Each of the interlace sets may include

$${M}_{interlace , k}^{PSFCH , n}$$

interlaces. The interlace sets may be indexed in an ascending order of interlace indices. For each interlace in the interlace set, all PRBs in the interlace may be used for the PSFCH transmission.

As an example, in a case where sl-PSFCH-Type=′type2′, within the set k of RBs, the terminal device may determine a subset of PRBs in a first interlace. Furthermore, the terminal device may determine

$${N}_{PRB}^{PSFCH}$$

subsets of PRBs in a second interlace based on a set of sidelink PSFCH RBs. These subsets of PRBs in the resource pool are used for transmitting the PSFCHs with HARQ-ACK information. The index of the first interlace is provided by sl-PSFCH-Type2-CommonInterlace.

$${N}_{PRB}^{PSFCH}$$

in the second interface is provided by sl-PSFCH-Type2-DedicatedPRB.

For an n^{th} PSFCH transmission opportunity, in a case where

$$1 \leq n \leq {N}_{occasion}^{PSFCH} ,$$

each interlace set (e.g., a first interlace) may include

$${M}_{PRB , k , l}^{PSFCH , n}$$

interlaces.

$${M}_{PRB , k , l}^{PSFCH , n}$$

may be a multiple of

$${N}_{PRB}^{PSFCH} .$$

For the first menace, the terminal device may determine a subset of PRBs based on an index s. The indices of these subsets of PRBs may be represented as PRB #1, PRB #2, . . . . PRB #n, respectively. These subsets of PRBs may be represented as:

$$\{ \cdot S , {N}_{PRB}^{PSFCH} \cdot s , {N}_{PRB}^{PSFCH} \cdot s + 1 , … , {N}_{PRB}^{PSFCH} \cdot ( s + 1 ) - 1 \} ;$$

wherein

$$0 \leq s \leq {M}_{PRB , k , l}^{PSFCH , n} / {N}_{PRB}^{PSFCH} - 1 .$$

The terminal device may arrange

$${M}_{subset , k}^{PSFCH , n}$$

subsets of PRBs in the interlace in an ascending order of the subset of PRBs indices.

$${M}_{subset , k}^{PSFCH , n}$$

may be a product of the number of subchannels in the set k of RBs and

$${M}_{PSSCH}^{PSFCH} .$$

Furthermore, for the set k of RBs, a subset of PRBs assigned to the terminal device in

$${M}_{subset , k}^{PSFCH , n}$$

subsets of PRBs is:

$$\{ ( i + j \cdot {N}_{PSSCH}^{PSFCH} ) \cdot {M}_{subch , slot , k}^{PSFCH , n} , ( i + j \cdot {N}_{PSSCH}^{PSFCH} ) \cdot {M}_{subch , slot , k}^{PSFCH , n} + 1 , … , ( i + 1 + j \cdot {N}_{PSSCH}^{PSFCH} ) \cdot {M}_{subch , slot , k}^{PSFCH , n} - 1 \} ;$$

wherein i may represent a time unit (e.g., slot), and j may represent a frequency range (e.g., subchannel). Each subset of PRBs may be represented by i and j to indicate the size of the resources. The indices of the subsets in subsets PRB (i, j) are PRB #1, PRB #2, . . . , PRB #n.

In some embodiments, the first terminal device may determine the COT resources on the shared spectrum by channel monitoring. Channel monitoring refers to monitoring to one or more channel resources by the first terminal device on the shared spectrum, or refer to monitoring to a target channel resource, which is not limited herein.

As an example, channel monitoring may refer to a process where the first terminal device listens to channel resources using the LBT mechanism, or a process where the first terminal device performs monitoring by methods such as channel sensing. For example, the first terminal device may determine occupancy of the sidelink resources based on a reference signal received power (RSRP) value of a sidelink DMRS.

The result of channel monitoring may indicate that the monitored channel resource is idle, or the monitored channel is occupied. Where the result of channel monitoring indicates that the channel resource is idle, the first terminal device may use this idle resource as the COT resource. Where the result of channel monitoring result indicates that the channel is occupied, the first terminal device may continue channel monitoring until the COT resource is determined.

As an example, the first terminal device may perform LBT on the shared spectrum, and determine the COT resource after a successful LBT. For example, the first terminal device may determine the COT resource by performing LBT Type 1.

As an example, in a case where the result of channel monitoring indicates that the channel is idle, the first terminal device may proceed with channel access. Alternatively, the first terminal device may perform PSSCH transmission or PSCCH transmission by channel access. Alternatively, the first terminal device may perform PSFCH transmission by channel access. For example, for channel access operations on the shared spectrum, the terminal device may transmit PSFCHs on a plurality of candidate occasions associated with the PSFCHs transmission.

Alternatively, the terminal device may transmit the PSSCHs only when PSFCHs related to the PSSCHs are not transmitted. For example, the terminal device may only transmit the first PSSCH in the current slot where no PSFCH associated with the first PSSCH has been transmitted in any of the previous slots of the plurality of slots where

$${N}_{occasion}^{PSFCH}$$

occasions are located.

In step S420, the first terminal device assigns the PSFCH resources to the plurality of terminal devices sharing the COT resources based on a first set of PSFCHs to be transmitted.

The plurality of terminal devices sharing the COT resources include the first terminal device that initiates the COT resources, as well as other terminal devices. Other terminal devices may be any one or more terminal devices performing channel sensing on the shared spectrum, or one or more terminal devices involved in sidelink communication with the first terminal device.

The plurality of terminal devices or other terminal devices may include the second terminal device as described above. The second terminal device may be any terminal device in the plurality of terminal devices, other than the first terminal device.

The second terminal device may determine the COT resources shared by the plurality of terminal devices in various ways. In some embodiments, the second terminal device may determine the COT resources through communication with the first terminal device. For example, the first terminal device may explicitly specify the COT resources in the SCI, and the second terminal device may determine the COT resources subsequent to receipt of the SCI. In some embodiments, the second terminal device may determine the COT resources through channel sensing.

In some embodiments, the second terminal device may be located within the network coverage area or outside the network coverage area. For example, the second terminal device located within the network coverage area may determine the COT resources based on the configuration of the network device. Alternatively, the second terminal device located outside the network coverage area may determine the COT resources through sidelink communication with the first terminal device.

In some embodiments, the second terminal device may receive the resource coordination information from the first terminal device, and then transmit feedback related to the resource coordination information to the first terminal device over SCI and/or a PSFCH.

When the first terminal device initiates the COT resources, the first terminal device may assign resources to other terminal devices sharing the COT resources. For example, the first terminal device may assign resources based on priorities of the other terminal devices. For example, the first terminal device may share the COT resources with other terminal devices while ensuring its own transmission requirements.

As shown in step S410, the COT resources include PSFCH resources. The first terminal device may assign the PSFCH resources to the plurality of terminal devices, including the second terminal device.

For example, the plurality of terminal devices may perform PSFCH transmission based on the resource assignment from the first terminal device.

For example, the second terminal device may transmit PSFCHs on the PSFCH resources assigned thereto by the first terminal device.

The first set of PSFCHs to be transmitted is used by the first terminal device for assigment of the PSFCH resources to improve the utilization of the PSFCH resources. In other words, for the PSFCH resources, when configuring the resources, the PSFCH transmissions required by the plurality of terminal devices are already considered. This is conducive to avoiding interruption of the COT resources due to the lack of transmission demands for the PSFCH resources, while improving resource utilization rate.

In some embodiments, the first set of PSFCHs may include part or all of the PSFCHs that need to be transmitted by the plurality of terminal devices sharing the COT resources. For example, when the transmission demands for all the PSFCHs to be transmitted by the plurality of terminal devices exceed the PSFCH resources in the COT resources, the first set of PSFCHs may include part of the PSFCHs to be transmitted by the plurality of terminal devices. Alternatively, when the transmission demands for all the PSFCHs to be transmitted by the plurality of terminal devices are less than or equal to the PSFCH resources in the COT resources, the first set of PSFCHs may include all the PSFCHs to be transmitted by the plurality of terminal devices.

In the above embodiments, when the first set of PSFCHs includes part of the PSFCHs, the plurality of terminal devices may rank the plurality of PSFCHs to be transmitted based on the priorities thereof, to ensure that PSFCHs with higher priorities are transmitted first.

As an implementation, the first terminal device may assign PSFCH resources to the plurality of terminal devices based on the first set of PSFCHs. For example, the PSFCHs in the first set of PSFCHs may correspond to different terminal devices, and the first terminal device may assign resources according to the needs of different terminal devices.

In some embodiments, the first set of PSFCHs may include all types of PSFCHs that need to be transmitted by the plurality of terminal devices. As an example, the first set of PSFCHs may include different types of PSFCHs and the number of PSFCHs corresponding to each type. In other words, the first set of PSFCHs may not be a collection of specific PSFCHs but rather a collection of different types of PSFCHs. In the first set of PSFCHs, the number of different types of PSFCHs transmitted ober the COT resources may be the same or different.

In some embodiments, the first set of PSFCHs may include a plurality of subsets of PSFCHs. Each subset of PSFCHs may correspond to a terminal device or a specific PSFCH type. For example, the first terminal device initiating the sharing and other terminal devices occupying the shared resources may determine the subset of PSFCHs to be transmitted.

The first set of PSFCHs or a first subset of PSFCHs within the first set of PSFCHs may be determined based on various information. In some embodiments, the PSFCHs in the first set of PSFCHs may be determined based on the priorities of part or all of the PSFCHs to be transmitted by the plurality of terminal devices. As an example, any terminal device sharing the COT resources may select a subset of PSFCHs to be transmitted based on the priorities. In some embodiments, the PSFCHs in the first set of PSFCHs may be determined based on the communication quality between the plurality of terminal devices and the first terminal device.

As one embodiment, the plurality of PSFCHs transmitted on the PSFCH resources may be selected based on priorities of all the PSFCHs to be transmitted, such that the first set of PSFCHs is determined.

As one embodiment, the plurality of PSFCHs transmitted on the PSFCH resources may be selected based on priorities of part of the PSFCHs to be transmitted, such that the first set of PSFCHs is determined.

As another embodiment, part of all of the PSFCHs to be transmitted by the plurality of terminal devices may be ranked based on priorities, and then the first set of PSFCHs may be determined according to the PSFCH resources. In other words, the PSFCH resources may prioritize the transmission demands for the PSFCHs with higher priorities.

As one embodiment, in resource scheduling, the first terminal device initiating the COT sharing and other terminal devices occupying the shared resources may select a subset of PSFCHs to be transmitted based on the priorities.

The priorities of part or all of the PSFCHs are determined based on one or more of: the priority of the terminal device transmitting the PSFCH, the priority of the service corresponding to the PSFCH, the urgency of the service corresponding to the PSFCH, and the communication environment or communication scenario in which the PSFCH is transmitted.

For example, in a case where a PSFCH corresponds to a more urgent service, the PSFCH resources may prioritize the transmission of the PSFCH, and therefore the ranking of that PSFCH in the first set of PSFCHs may be relatively high.

As another example, in a case where the communication environment for transmitting a PSFCH is of poor quality, the ranking of the PSFCH may be relatively low.

In some embodiments, the first terminal device may assign the PSFCH resources to the plurality of terminal devices based on the first set of PSFCHs to be transmitted and the PSFCH resources.

For example, in a case where the PSFCH resources include a plurality of sets of PRBs, different set of resources indices may be associated with the service mode or the service type of the terminal device. For instance, for terminal devices executing urgent or higher-priority services, the first terminal device may assign more PRBs to these terminal devices. For terminal devices executing non-urgent services, the first terminal device may assign fewer PRBs to these terminal devices accordingly. In other words, the first terminal device may assign resources to the plurality of terminal devices according to the actual needs.

In some embodiments, the first terminal device may assign the PSFCH resources for the plurality of terminal devices based on the first set of PSFCHs ranked by priorities.

The first terminal device may determine the first set of PSFCHs at a plurality of moments. For example, the first terminal device may determine the first set of PSFCHs subsequent to determination of the COT resources, so as to assign resources more reasonably. Subsequent to determination of the COT resources, a time-domain range of the COT resources is fixed, which allows for more reasonable resource assignment. As another example, the first terminal device may determine the first set of PSFCHs prior to determining the COT resources, in order to monitor the COT resources. Prior to determination of the COT resources, although it is not clear whether the monitored resources are idle, the PSFCH transmission demands are already known. Therefore, targeted channel monitoring may be performed.

In some embodiments, in a case where the terminal device determines the COT resources through LBT, the sequence between performing LBT and determining the first set of PSFCHs may not be specified. The process of determining the first set of PSFCHs may include a procedure where the PSFCHs are ranked based on the priorities thereof.

In some embodiments, subsequent to determination of the COT resources, the first terminal device may rank, based on the priorities, the PSFCHs to be sent by the plurality of terminal devices, either partially or completely, to determine the first set of PSFCHs.

For example, the plurality of terminal devices may determine the subsets of PSFCHs subsequent to determination of the COT resources. As an example, the terminal device may rank the PSFCH based on priorities upon acknowledge of an LBT result for PSFCH transmission.

In some embodiments, the first terminal device may rank, based on priorities, the PSFCHs to be transmitted by the plurality of terminal devices, either partially or completely, prior to determining the COT resources, in order to determine the first set of PSFCHs.

As an example, the plurality of terminal devices may determine the subsets of PSFCHs prior to determining the COT resources. For example, the terminal device may rank the PSFCHs based on priorities before the LBT result for PSFCH transmission is known.

As illustrated in FIG. 4, the first terminal device may assign the PSFCH resources based on the set of PSFCHs to be transmitted, to ensure that each PSFCH occasion in the COT resources has a transmission demand. In this way, interruption of the COT resources is avoided as much as possible.

However, the terminal devices sharing the COT resources may choose not to transmit the PSFCHs for various reasons subsequent to being assigned the PSFCH resources. In a case where a terminal device does not transmit PSFCHs on its assigned PSFCH resources, resource waste is caused, but also, interruption of the COT resources may be caused due to lack of continuous transmission on the PSFCH resources. For example, in a case where both the first terminal device initiating the COT resources and other terminal devices sharing the COT resources do not transmit PSFCHs at some PSFCH occasions, a longer transmission gap may arise, which potentially leads to interruption of the COT resources.

To avoid interruption of the COT resources, some embodiments of the present disclosure further provide a method for sidelink communication. By the method, in a case where the first terminal device or the second terminal device determines not to transmit PSFCHs on the assigned PSFCH occasions, the first terminal device or the second terminal device may transmit sidelink channels or reference signals other than the PSFCHs to improve the continuity of sidelink transmission.

In some embodiments, in a case where a first PSFCH occasion is assigned to the first terminal device, the first terminal device may determine whether to transmit a PSFCH on the first PSFCH occasion. In a case where the first terminal device does not transmit the PSFCH on the first PSFCH occasion, the first terminal may determine whether to transmit a sidelink channel or a reference signal other than the PSFCH on the first PSFCH occasion or on a time-domain resource where the first PSFCH occasion is located.

As an example, in a case where the first terminal device initiating the COT resources and other terminal devices sharing the COT resources do not intend to transmit PSFCHs at some PSFCH occasions within the COT resources, these terminal devices may transmit reference signals similar to the PSFCHs on the (pre-configured) PSFCH resources.

In some embodiments, in a case where the second PSFCH occasion is assigned to the second terminal device, the second terminal device may similarly determine whether to transmit a PSFCH at the second PSFCH occasion and whether to send other channels or signals. For simplicity, the following description may use the first terminal device performing the method as an example.

Sidelink channels other than the PSFCHs may be PSSCHs or PSCCHs, which are not limited herein.

As an example, a plurality of terminal devices may transmit the PSSCHs or the PSCCHs on the PSFCH occasions. During resource configuration, the first terminal device initiating the COT resources may optionally configure a portion of the PSFCH resources to be used for PSSCHs or PSCCHs. Whether this portion of the resources are used for PSSCHs or PSCCHs is optional.

For example, in the PSFCH resources, transmissions of ACK and NACK are prioritized (with highest priorities). Where there are no ACK and NACK to transmit, the PSSCHs or the PSCCHs may occupy the PSFCH occasions and corresponding resource configurations.

In some embodiments, the reference signal may be a signal similar to a PSFCH to help to determine whether the resource is being used. For example, the reference signal may be a DMRS or CSI.

As an example, the reference signal transmitted on a PSFCH occasion may be a signal sequence on an (optionally) configured interleaved pattern. Taking the transmission occasion of type 2 PSFCH as an example, each PSFCH may occupy one public resource and three dedicated resources. In a case where the terminal device transmits a reference signal on the PSFCH occasion, the reference signal may not occupy all the resources. For instance, when the terminal device transmits the reference signal on the PSFCH occasion, the reference signal may be transmitted only on dedicated resources of the PSFCH occasion. In other words, the terminal device does not transmit the reference signal in place of the PSFCH on the public resource of the PSFCH occasion. Alternatively, the terminal device may repeatedly transmit, on the public resource, the same data that is transmitted on the dedicated resources.

In some embodiments, the first terminal device may also determine whether another terminal device may transmit a PSFCH on the first PSFCH occasion. Where a PSFCH needs to be transmitted, the another terminal may be given the priority to transmit the PSFCH.

The time-domain resource where the first PSFCH occasion is located refers to another resource that is overlapped with the first PSFCH occasion in the time domain. The another resource has the same time-domain as the first PSFCH occasion but differs in the frequency domain. The terminal device may transmit a channel or signal on these other resources to avoid interruption of the COT resources.

In some embodiments, the first terminal may determine, based on first information, whether to transmit a sidelink channel or a reference signal other than the PSFCH on the first PSFCH occasion or on a time-domain resource where the first PSFCH occasion is located. In other words, the first terminal device does not immediately transmit other channels or signals subsequent to determining not to transmit the PSFCH, but instead determines whether to transmit the other channels or signals based on a judgment or information.

The first information may be related to one or more of the following: SCI indication information, the type of service of the terminal device, and the number of PSFCH occasions that are not used.

In some embodiments, the first information may be carried in the SCI to help the terminal devices sharing the COT resources tp determine the first information. The SCI may include a dedicated indication field to indicate the first information.

As an example, the first terminal device may configure the SCI to indicate the first information. The first terminal device may define an indication field in the SCI to serve as the first information that indicates whether the PSFCH resources may be shared with PSSCHs or PSCCHs.

For instance, one bit in the indication field may be used to indicate the first information. A bit value of “0” means that the PSFCH resources may not be used for PSSCHs/PSCCHs, while a bit value of “1” means that the PSFCH resources may be used for PSSCHs/PSCCHs. Conversely, the definitions of “0” and “1” may be swapped.

In some embodiments, the first information is related to the type of service of the terminal device. In other words, the first information is related to a plurality of service types of the plurality of terminal devices. For example, the first information may indicate a first group of service types and a second group of service types. The first service type group corresponds to sidelink channel transmissions, excluding the PSFCHs, which share the PSFCH resources, while the second service type group corresponds to sidelink channel transmissions, excluding the PSFCHs, that do not share the PSFCH resources.

As an example, the first information is further used to indicate that terminal devices corresponding to the second service type group transmit reference signals on the PSFCH resources on which the PSFCHs are not transmitted. In other words, in a case where the resource configuration indicates that a some service types fails to share the PSFCH resources for PSSCHs or PSCCHs, these PSFCH resources may instead be used to transmit reference signals.

For example, the first information may also indicate three service type groups. The PSFCH resources in a first service type group can be shared with other channels. The PSFCH resources in a second service type group can be shared with reference signals. The PSFCH resources in a third service type group cannot be shared with other channels or signals.

As an example, for transmission configurations of different service types, terminal devices sharing the COT resources need to be aware of the configurations. After the first terminal device accesses a cell, a base station may inform the first terminal device of resource usage rules for different service types over a Uu interface. The first terminal device may then notify the resource usage rules to other terminal devices. For example, the first terminal device may notify the resource usage rules to other terminal devices via SCI.

In some embodiments, the first information is related to indication information of the SCI and the type of service of the terminal device. As an example, the first terminal device may determine whether the bit in the SCI indication field is “0” or “1” based on the service types of different terminal devices. As an example, the correlation between the first information and the service type of the terminal device may be configurable. For example, the first terminal device may configure a plurality of service levels via SCI. Each service level may explicitly indicate whether its PSSCHs/PSCCHs can share the PSFCH resources.

In some embodiments, the first information may also be related to the PSFCH resources that are not used. That is, the terminal device may determine whether to use other PSFCH resources for other channels or signals based on wasted PSFCH resources. For example, in a case where the number of assigned PSFCH occasions that are not used by a terminal device exceeds a threshold, PSSCH data or PSCCH information may be transmitted in the remaining PSFCH resources.

As an example, the first terminal device or the second terminal device may determine a first parameter. The first parameter may indicate the number of PSFCH occasions that are not used within a first time period. In a case where the first parameter is greater than a first threshold, the first terminal device transmits a sidelink channel or reference information, other than the PSFCH, on a PSFCH occasion within a second time period. The second time period is an adjacent time period that follows the first time period.

In the above example, the first time period may be any statistical period, and the second time period may be a next statistical period following the first time period.

As an implementation, the first terminal device may determine the first parameter by using a counter. For example, the first terminal device may configure a counter for any terminal device among the terminal devices sharing the COT resources. Within a time period, the counter is used to count the number of PRBs that are not used in a plurality of PSFCH occasions assigned to the terminal device. Each time a PSFCH occasion or a PRB (indicated by 0) is not used, the counter is incremented by 1. In a case where the number of Os counted by the counter exceeds the first threshold, the PSSCHs are transmitted on the PSFCH resources within a next time period.

As an implementation, the second terminal device may determine the first parameter by using a counter set by itself, such that whether to transmit the PSSCHs on the PSFCHs resources is determined. As another implementation, the second terminal device may also directly determine whether to transmit the PSSCHs on the PSFCH resources based on the information in the indication field of the SCI from the first terminal device.

As an example, the first terminal device or the second terminal device may determine a second parameter. The second parameter is used to indicate the number of PSFCH occasions that are not used before a current time within a first time period; and In a case where the second parameter is greater than a second threshold, the first terminal device transmits sidelink channels or reference information other than the PSFCHs on the remaining PSFCH occasions within the first time period.

As an implementation, the first terminal device may determine the first parameter by using a counter. For example, the first terminal device may configure a counter for any terminal device among the terminal devices sharing the COT resources. In a plurality of slots within a time period, the counter is used to count the number of PRBs that are not used in a plurality of PSFCH occasions assigned to the terminal device. Each time a PSFCH occasion or a PRB (indicated by 0) is not used, the counter is incremented by 1. In a case where the number of Os counted by the counter is greater than the second threshold, the PSSCHs are transmitted on the PSFCH resources within the remaining slots within the time period.

As an example, the first threshold and the second threshold may be equal or different from each other.

As an example, the threshold indicating whether to transmit another channel in the PSFCH resources may be carried in the SCI. For example, the first information may include the first threshold and/or the second threshold. It should be understood that the first threshold or the second threshold may also not be a parameter in the first information. The terminal device may directly determine, based on any threshold, whether the PSFCH resources are shared.

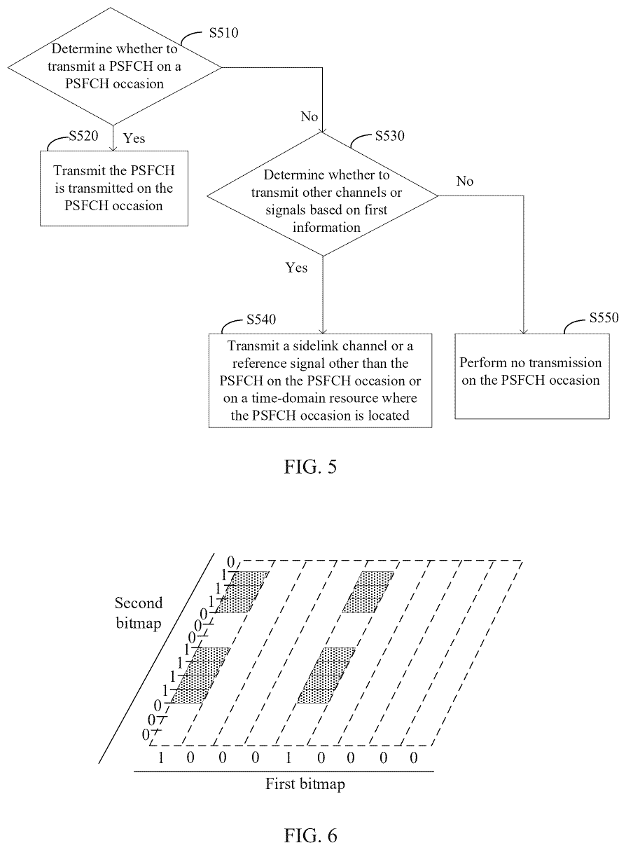

The exemplary embodiments of methods for determining whether to transmit other channels or signals on the PSFCH resources based on the first information are described above. For ease of understanding, the method is exemplarily illustrated with reference to FIG. 5. The method is performed by the first terminal device or the second terminal device.

Referring to FIG. 5, in step S510, whether to transmit a PSFCH on a PSFCH occasion is determined. In a case where it is determined to transmit a PSFCH on a PSFCH occasion, step S520 is performed; and otherwise, step S530 is performed. The PSFCH occasion in step S510 refers to a PSFCH occasion assigned to a terminal device performing this step within COT resources. For example, the first terminal device corresponds to a first PSFCH occasion, and the second terminal device corresponds to a second PSFCH occasion.

In step S520, the PSFCH is transmitted on the PSFCH occasion.

In step S530, whether to transmit other channels or signals is determined based on first information. In a case where it is determined to transmit other channels or signals, step 540 is performed; and otherwise, step 550 is performed.

In step S540, a sidelink channel or a reference signal other than the PSFCH is transmitted on the PSFCH occasion or on a time-domain resource where the PSFCH occasion is located. That is, PSFCH resources may be shared.

In step S550, no transmission is performed on the PSFCH occasion. That is, PSFCH resources may not be shared.

The method of determining whether other channels or reference signals may share PSFCH resources is described above with reference to FIG. 5. In the above embodiments, the terminal device needs to determine which PSFCH resources have been used and which PSFCH resources have not been used. Under a condition that the PSFCH resources have not been used, any terminal device may transmit PSSCH data or PSCCH information or the reference signal based on SCI (first information) to avoid interruption of the COT resources. Therefore, how a plurality of terminal devices sharing the COT resources quickly determine whether the resources have been used is also a technical issue that needs to be addressed.

It should be understood that the terminal device may be the first terminal device or the second terminal device as described above, which is not limited herein.

In some embodiments, the PSFCH resources may include a plurality of candidate PSFCH occasions. That is, within the COT resources, the plurality of candidate PSFCH occasions may be available for PSFCH transmission.

In some embodiments, the candidate PSFCH occasions may include pre-configured PSFCH occasions as described above, or may include dynamically configured PSFCH occasions, which is not limited herein.

The first terminal device determines whether the plurality of candidate PSFCH occasions are valid based on second information. Alternatively, the second information is used to indicate whether part or all of the plurality of candidate PSFCH occasions are valid.

As an example, a valid candidate PSFCH occasion may indicate that the resource where the candidate PSFCH occasion is located has not been used or has been used. An invalid candidate PSFCH occasion may indicate that the resource where the candidate PSFCH occasion is located has been used.

In some embodiments, the second information may indicate the candidate PSFCH occasions at different granularities. Exemplarily, the indication is given at the granularity of unit blocks or subsets of PRBs in each set of RBs. Within a slot that includes the PSFCH, for each set of RBs, a resource indication of each candidate PSFCH occasion is necessary to improve resource utilization.

In some embodiments, the second information may include a first bitmap determined based on mapping relationships between the plurality of candidate PSFCH occasions and a plurality of subsets of PRBs. Based on the mapping relationships, the first bitmap may indicate whether resources for all candidate PSFCH occasions are valid. The first bitmap may also indicate different configurations corresponding to a set of resources where each candidate PSFCH occasion is located. During giving the indication in the form of the first bitmap, the terminal device may quickly query the correlation between the candidate PSFCH occasion and the subset of PRBs with no need of storing detailed correlation information. Further, the terminal device may use the first bitmap for quick query and analysis.

It should be understood that the first bitmap indicating the mapping relationships between the plurality of candidate PSFCH occasions and the plurality of subsets of PRBs is only an example, and the first bitmap may also indicate correlations between the plurality of candidate PSFCHs and various types of configured resource subsets. Each type of resource subset may be configured and indicated by a bitmap according to the embodiments of the present disclosure. The resource subsets at a smaller granularity are configured, which helps to achieve a more refined reserved resource pattern and improve indication accuracy.

As an example, the mapping relationships between the plurality of candidate PSFCH occasions and the plurality of subsets of PRBs may include the mapping relationships between the plurality of candidate PSFCHs and indices of the plurality of subsets of PRBs.

As an example, the plurality of candidate PSFCH occasions are in one-to-one correspondence with the plurality of subsets of PRBs.

In some embodiments, the first bitmap may indicate whether the plurality of candidate PSFCH occasions are valid by indicating the plurality of subsets of PRBs. Exemplarily, the first bitmap may indicate the (pre-) configuration of resources corresponding to N candidate PSFCH occasions, such that the N candidate PSFCH occasions are associated with N different subsets of PRBs. Therefore, the terminal device may determine the available PRBs for each candidate PSFCH occasion in a set of sidelink PSFCH RBs based on the corresponding bitmap. That is, the PSFCH resources described above may be indicated based on the bitmap.

In some embodiments, the first bitmap may include a first sub-bitmap and a second sub-bitmap. Each bit in the first sub-bitmap corresponds to a time unit, and thus the first sub-bitmap may also be referred to as a time-domain bitmap. Each bit in the second sub-bitmap corresponds to a resource block within a unit frequency band, and thus the second sub-bitmap may also be referred to as a frequency-domain bitmap.

As an example, basic building blocks of the set of resources set may include one or more slots in the time domain and may also include one or more subchannels in the frequency domain.

As an example, the first sub-bitmap and the second sub-bitmap may form a two-dimensional bitmap, i.e., the first bitmap.

As an example, the first sub-bitmap (bitmap-1) may represent a set of orthogonal frequency division multiplex (OFDM) symbols within the slot (within one or more slots). For example, the first sub-bitmap may be composed of X bits.

As an example, the time unit corresponding to each bit in the first sub-bitmap may be any of a symbol, a slot, a subframe, or a radio frame, which is not limited herein. The time unit may also be referred to as a length of the first sub-bitmap.

As an example, the second sub-bitmap (bitmap-2) may represent a set of resource elements (e.g., subset of PRBs) in the frequency domain. The unit frequency band corresponding to each bit in the second sub-bitmap may be determined based on the definition of the set of resources. The unit frequency band corresponding to each bit may also be referred to as a length of the second sub-bitmap.

As an example, the number of bits in the second sub-bitmap is determined based on a subcarrier spacing (SCS) and/or a unit frequency band. The number of bits in the second sub-bitmap is also the number of bits in the second sub-bitmap that are used to indicate the PSFCH resources.

As an implementation, the number of bits in the second sub-bitmap is determined based on the SCS. For example, the number of bits is adjusted based on the SCS. As an example, for an SCS of 15 KHz, the number of bits is L; for an SCS of 30 KHz, the number of bits is 2×L; and for an SCS of 60 KHz, the number of bits is 4×L. Still for example, the number of bits is constantly the same regardless of what SCS is used.

As an implementation, the number of bits in the second sub-bitmap is determined based on the unit frequency band. The unit frequency band is related to a definition level of the set of resources. In a case where the set of resources is defined at a carrier level, the unit frequency band corresponds to the number of resource blocks within the carrier. In a case where the set of resources is specific to a bandwidth part, the unit frequency band is given by the bandwidth of the bandwidth part.

As an example, the same second sub-bitmap is valid for all OFDM symbols/slots represented by the first sub-bitmap. That is, the same resource element set is reserved in all OFDM symbols represented by the first sub-bitmap. In addition, a frequency domain granularity of the set of resources configuration provided by the second sub-bitmap is a resource block. In other words, all resource elements in the (frequency domain) resource block are either reserved or not.

For ease of understanding, the first bitmap is illustrated exemplarily hereinafter with reference to FIG. 6. The first bitmap of FIG. 6 includes a first sub-bitmap and a second sub-bitmap. The first sub-bitmap includes nine bits and the second sub-bitmap includes 14 bits.

As shown in FIG. 6, among the nine bits of the first sub-bitmap, the first bit and the fifth bit are both set to 1, and the remaining bits are all set to 0. Among the 14 bits of the second sub-bitmap, the fourth to the seventh bits and the eleventh to the thirteenth bits are all set to 1, and the remaining bits are set to 0. A bit which is set to 1 may indicate that the OFDM symbol or the resource at a frequency domain granularity corresponding to the bit is valid, and a bit which is set to 0 may indicate that the resource is invalid.

Referring to FIG. 6, each bit in the second sub-bitmap may indicate a subchannel. Each shaded box in the first bitmap may indicate a resource subset. All shaded portions may indicate a plurality of resource subsets that are currently valid, that is, a plurality of candidate PSFCH occasions that are not currently used.

In some embodiments, the second information may include a second bitmap that indicates whether the plurality of candidate PSFCH occasions are valid at different time-domain positions. The second bitmap may include a first sub-bitmap, a second sub-bitmap, and a third sub-bitmap. The first sub-bitmap and the second sub-bitmap have been described above, which is not described herein any further.

As an example, the usage of the plurality of candidate PSFCH occasions varies at different time-domain positions. The second bitmap may represent such variations via the third sub-bitmap. The third sub-bitmap may represent whether resources are valid or not at different time units. That is, the third sub-bitmap may represent the relationship between resource validity and the time unit (e.g., slot). Therefore, the third sub-bitmap may also be referred to as a relationship bitmap, or a validity bitmap.

As an implementation, the PSFCH resources configured in the COT resources are all semi-statically or dynamically controllable. In the case of semi-static control, the third sub-bitmap (bitmap-3) may determine whether the set of resources defined by the first sub-bitmap or the second sub-bitmap is valid or not in a given slot. In other words, within the entire time-domain period of a semi-static set of resources defined by a triplet {bitmap-1, bitmap-2, bitmap-3}, and N candidate PSFCH occasions may be associated with N different subsets of PRBs, and may indicate whether the resources are valid or available at a specific time point.

As an example, each bit in the third sub-bitmap corresponds to a time unit. For example, the granularity of the third sub-bitmap may be equal to the time unit of the first sub-bitmap.

As an implementation, different time domain positions may correspond to the time units of the third sub-bitmap. For example, when the time unit is a slot, different time domain positions represent different slots.

As an example, each bit in the third sub-bitmap may be denoted as t. t may represent time points corresponding to different symbols/slots. For example, t=1, 2, 3, . . . , T, wherein T represents the number of symbols/slots in which a plurality of candidate PSFCH occasions (PSFCH resources) are located.

In summary, when a plurality of resource subsets are configured for semi-static or dynamic activation, the terminal device may indicate the resource usage status of a specific resource subset in a more refined manner for a given slot, thereby representing the correlation between the slot and the resource subset.

As previously mentioned, in a subset of PRBs, i and j may be used to indicate a size of the resources. As an example, a three-dimensional matrix M composed of the aforementioned three sub-bitmaps may represent a time-domain-frequency-domain relation bitmap. The second bitmap, as the three-dimensional bitmap, may indicate whether a plurality of subsets of PRBs are being used at the current moment.

In some embodiments, the second bitmap may determine a third parameter. The third parameter is used to indicate whether any of the N subsets of PRBs is being used. As an example, the third parameter may be determined based on the bitmap matrix M and the indices of the N subsets of PRBs. The bitmap matrix M may be a three-dimensional matrix M[i][j][t], wherein the index of an x^{th} subset of PRBs in the N subsets of PRBs is PRB #x. Therefore, a third parameter of the x^{th} subset of PRBs may be M[i][j][t]>[PRB #x], wherein 1≤x≤N, i represents a time unit, j represents a unit frequency band, t represents a t^{th} time unit in T time units where the N subsets of PRBs are located, and t=1, 2, . . . , T.

As an example, the time unit is a slot, and in a case where M[i][j][t]>[PRB #x]=1, the x^{th} subset of PRBs with index PRB #x is being used in slot t; and in a case where M[i][j][t]>[PRB #x]=0, the x^{th} subset of PRBs with index PRB #x is not being used in slot t. Accordingly, the second bitmap helps the terminal device to simultaneously determine how the relationship between resources changes with the slot and the set of resources. The terminal device may know or understand the relationships between different resource subset indices PRB #x by determining or reading the value of M[i][j][t]>[PRB #x]. Furthermore, the terminal device may also determine the usage of reserved PSFCH resources in different slots and resource subsets based on the value of M[i][j][t]>[PRB #x]. For example, in a case where a resource is being used at a specific moment, a corresponding bitmap cube element may be set to 1; and otherwise, corresponding bitmap cube element remains 0. The second bitmap allows for easier management of resource assignment and determination of the usage of monitoring resources.

In some embodiments, the second information may also include a third bitmap. The third bitmap may use a sub-bitmap to indicate the resources of the N candidate PSFCH occasions. Exemplarily, to use a sub-bitmap to indicate the resources of the N candidate PSFCH occasions, an N×M bitmap matrix may be created, wherein N represents the number of candidate PSFCH occasions, and M represents a total number of resources. In the third bitmap, each row of the bitmap matrix represents a candidate PSFCH occasion, and each column represents a resource. That is, for each candidate PSFCH occasion, the bitmap of the corresponding row may be used to indicate the resource required by the candidate PSFCH occasion. For each resource of each candidate PSFCH occasion, in a case where the corresponding bitmap matrix element (corresponding to the row of the PSFCH occasion and the column of the resource) is set to 1, the resource is being used; or in a case where the corresponding bitmap matrix element set to 0, the resource is not being used.

In some embodiments, based on the bitmap matrix M[i][j][t] as described above (with an initial bitmap matrix being M₀), a plurality of actual bitmap matrices M′ within a specific time period T (e.g., the T time units where the PSFCH resources are located) may be set. Based on the initially bitmap matrix M₀, the correlation of resource assignment may be formed. As each slot or symbol (time unit) changes, the PSFCH resources assigned to a specific slot may either may not be used or may have been used. Therefore, the actual bitmap matrix, with the resources actually used, may also change.

As an example, after each slot or symbol, the actual bitmap matrix is updated to M′ₜ, t ∈[1,T].

As an example, the summation of t ME matrices may represent the actual usage of resources after the time unit t. Furthermore, the initial bitmap matrix M₀ and the plurality of actual bitmap matrices M′ that have been used may together determine the number of subsets of PRBs that are not used in the PSFCH resources.

As an example, the second bitmap may be used to determine a fourth parameter. The fourth parameter may indicate the number of subsets of PRBs that are not used in the PSFCH resources. In other words, the fourth parameter may also indicate the usage of the PSFCH resources. As an example, the fourth parameter may be represented by a matrix C. The matrix C is determined based on the initial bitmap matrix M₀ and the actual bitmap matrix Mt following a t^{th} time unit, and may be represented as:

$$C = T \times {M}_{0} - {\sum }_{t = 1}^{T} {M}_{t}^{′} ;$$

wherein T represents the number of time units in the time domain of the PSFCH resources, and t=1, 2, . . . , T. The initial bitmap matrix M₀ represents an initial configuration where the PSFCH resources are not used, as described above. In a case where the time unit is a slot, the actual bitmap matrix M′ₜ may represent the real-time usage of the resources following slot t. Apparently, the terminal device may determine the real-time usage of the PSFCH resources based on the fourth parameter, such that by using the above method, other channels or reference signals are timely transmitted on the PSFCH resources that are not used, and hence interruption of the COT resources is avoided.

As an example, in a case where the initial bitmap matrix is the three-dimensional matrix M[i][j][t], the elements in the matrix C at a specific moment may be represented as C(i, j). As t changes, by sequentially selecting C(x, y)=max {C(i, j)}, the terminal device with the maximum number of resources that are not used may be determined. In this scenario, the first terminal device initiating COT resource sharing may adjust the resources of terminal devices that do not use PSFCH resources, or the PSFCH resources assigned to those terminal devices may be used to transmit PSSCH data, PSCCH information, or reference signals, in order to avoid interruption of the COT resources.

It should be understood that the various method embodiments in the present disclosure are intended to solve the same or different problems, and without conflict, these method embodiments may be combined together to improve communication efficiency.

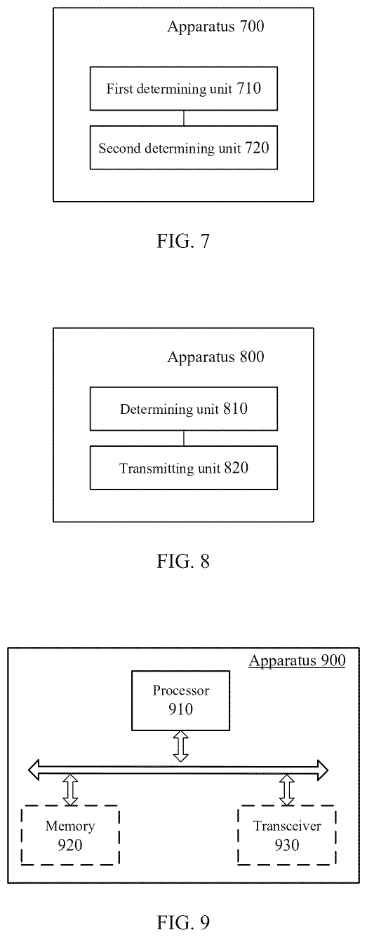

The method embodiments of the present disclosure have been described in detail with reference to FIG. 4 to FIG. 6. Hereinafter, some apparatus embodiments of the present disclosure are described in detail with reference to FIG. 7 to FIG. 9. It should be understood that the description of the apparatus embodiments corresponds to the description of the method embodiments, such that the parts that are not described in detail may be referred to the preceding method embodiments.

FIG. 7 is a schematic block diagram of an apparatus 700 for sidelink communication according to some embodiments of the present disclosure. The apparatus 700 may be any terminal device as described above. The apparatus 700 as illustrated in FIG. 7 includes a first determining unit 710 and a second determining unit 720.

The first determining unit 710 is configured to determine COT resources in shared spectrum, wherein the COT resources include PSFCH resources for transmitting PSFCHs.

The second determining unit 720 is configured to assign the PSFCH resources to a plurality of terminal devices sharing the COT resources based on a first set of PSFCHs to be transmitted, wherein the plurality of terminal devices include the first terminal device.

In some embodiments, PSFCHs in the first set of PSFCHs are determined based on priorities of part or all of PSFCHs to be transmitted by the plurality of terminal devices.

In some embodiments, the apparatus 700 further includes a processing unit, configured to, subsequent to determination of the COT resources, rank, based on priorities, part of all of PSFCHs to be transmitted by the plurality of terminal devices to determine the first set of PSFCHs; or prior to determination of the COT resources, rank, based on priorities, part of all of PSFCHs to be transmitted by the plurality of terminal devices to determine the first set of PSFCHs.

In some embodiments, the apparatus 700 further includes: a first transmitting unit, configured to transmit resource coordination information to a second terminal device in the plurality of terminal devices; and a receiving unit, configured to receive feedback information related to the resource coordination information, wherein the feedback information is carried in SCI and/or a PSFCH.

In some embodiments, the PSFCH resources include a first PSFCH occasion for the first terminal device, and the apparatus 700 further includes: a third determining unit, configured to determine whether to transmit a PSFCH on the first PSFCH occasion; and a fourth determining unit, configured to, in a case where the first terminal device does not transmit the PSFCH on the first PSFCH occasion, determine, based on first information, whether to transmit a sidelink channel or a reference signal other than the PSFCH on the first PSFCH occasion or on a time-domain resource where the first PSFCH occasion is located.

In some embodiments, the first information is carried in the SCI.

In some embodiments, the first information is related to a plurality of service types of the plurality of terminal devices, and the first information is used to indicate a first service type group and a second service type group in the plurality of service types, wherein sidelink channels, other than the PSFCHs, corresponding to the first service type group share the PSFCH resources, and sidelink channels, other than the PSFCHs, corresponding to the second service type group do not share the PSFCH resources.

In some embodiments, the first information is further used to indicate that terminal devices corresponding to the second service type group transmit reference signals on the PSFCH resources on which the PSFCHs are not transmitted.

In some embodiments, the PSFCH resources include a plurality of PSFCH occasions, and the apparatus 700 further includes: a fifth determining unit, configured to determine a first parameter, wherein the first parameter is used to indicate a number of PSFCH occasions that are not used within a first time period; and a second transmitting unit, configured to transmit sidelink channels or reference information other than the PSFCHs on PSFCH occasions within a second time period in a case where the first parameter is greater than a first threshold, wherein the second time period is a time period immediately following the first time period.

In some embodiments, the PSFCH resources include a plurality of PSFCH occasions, and the apparatus 700 further includes: a six^{th} determining unit, configured to determine a second parameter, wherein the second parameter is used to indicate a number of PSFCH occasions that are not used before a current time within a first time period; and a third transmitting unit, configured to transmit sidelink channels or reference information other than the PSFCHs on remaining PSFCH occasions within the first time period in a case where the second parameter is greater than a second threshold.

In some embodiments, the PSFCH resources include a plurality of PSFCH occasions, and the apparatus 700 further includes a seventh determining unit, configured to determine, based on second information, whether the plurality of candidate PSFCH occasions are valid.

In some embodiments, the second information includes a first bitmap, wherein the first bitmap is determined based on mapping relationships between the plurality of candidate PSFCH occasions and a plurality of subsets of PRBs, and the first bitmap includes a first sub-bitmap and a second sub-bitmap, each bit in the first sub-bitmap corresponding to a time unit, and each bit in the second sub-bitmap corresponding to a resource block within a unit frequency band.

In some embodiments, a number of bits in the second sub-bitmap is determined based on a subcarrier spacing and/or the unit frequency band.

In some embodiments, the second information further includes a second bitmap indicating whether the plurality of candidate PSFCH occasions are valid at different time-domain positions, wherein the second bitmap includes a first sub-bitmap and a second sub-bitmap, and a third sub-bitmap, each bit in the third sub-bitmap corresponding to a time unit.

In some embodiments, the second bitmap is configured to determine a third parameter, wherein the third parameter is used to indicate whether any of N subsets of PRBs is used, and the third parameter is determined based on a bitmap matrix M and indices of the N subsets of PRBs, an x^{th} subset of PRBs in the N subsets of PRBs having an index of PRB #x, and the x^{th} subset of PRBs having a third parameter of M[i][j][t]>[PRB #x], wherein N is a positive integer, 1≤x≤N, i represents a time unit, j represents a unit frequency band, t represents a t^{th} time unit in T time units where the N subsets of PRBs are located, and t=1, 2, . . . , T.

In some embodiments, the second bitmap is configured to determine a fourth parameter, wherein the fourth parameter is used to indicate a number of subsets of PRBs that are not used in the PSFCH resources, and the fourth parameter is represented by a matrix C, wherein the matrix C is determined based on an initial bitmap matrix M₀ and an actual bitmap matrix M′ₜ following a t^{th} time unit, and the matrix C is represented as:

$$C = T \times {M}_{0} - {\sum }_{t = 1}^{T} {M}_{t}^{′} ;$$

wherein T represents the number of time units in the time domain of the PSFCH resources, and t=1, 2, . . . , T.

FIG. 8 is a schematic block diagram of an apparatus 800 for sidelink communication according to some embodiments of the present disclosure. The apparatus 800 may be any second terminal device as described above. The apparatus 800 as illustrated in FIG. 8 includes a determining unit 810 and a transmitting unit 820.

The determining unit 810 is configured to determine COT resources shared by a plurality of terminal devices, wherein the COT resources include PSFCH resources for transmitting PSFCHs, the plurality of terminal devices including a first terminal device and the second terminal device.

The transmitting unit 820 is configured to transmit a PSFCH on a PSFCH resource assigned by the first terminal device to the second terminal device based on a first set of PSFCHs to be transmitted.

In some embodiments, PSFCHs in the first set of PSFCHs are determined based on priorities of part or all of PSFCHs to be transmitted by the plurality of terminal devices.

In some embodiments, the apparatus 800 further includes a receiving unit, configured to receive resource coordination information from the first terminal device, and the transmitting unit 820 is further configured to transmit feedback information related to the resource coordination information to the first terminal device, wherein the feedback information is carried in SCI and/or a PSFCH.

In some embodiments, wherein the PSFCH resources include a second PSFCH occasion for the second terminal device, and the determining unit is further configured to determine whether to transmit a PSFCH on the second PSFCH occasion, and in a case where the second terminal device does not transmit the PSFCH on the second PSFCH occasion, the determining unit is further configured to determine, based on first information, whether to transmit a sidelink channel or a reference signal other than the PSFCH on the second PSFCH occasion or on a time-domain resource where the second PSFCH occasion is located.

In some embodiments, the first information is carried in the SCI.

In some embodiments, the first information is related to a plurality of service types of the plurality of terminal devices, and the first information is used to indicate a first service type group and a second service type group in the plurality of service types, wherein sidelink channels, other than the PSFCHs, corresponding to the first service type group share the PSFCH resources, and sidelink channels, other than the PSFCHs, corresponding to the second service type group do not share the PSFCH resources.

In some embodiments, the first information is further used to indicate that terminal devices corresponding to the second service type group transmit reference signals on the PSFCH resources on which the PSFCHs are not transmitted.

In some embodiments, the PSFCH resources include a plurality of PSFCH occasions, and the determining unit 810 is further configured to determine a first parameter, wherein the first parameter is used to indicate a number of PSFCH occasions that are not used within a first time period; and the transmitting unit 820 is further configured to transmit sidelink channels or reference information other than the PSFCHs on PSFCH occasions within a second time period in a case where the first parameter is greater than a first threshold, wherein the second time period is a time period immediately following the first time period.

In some embodiments, the PSFCH resources include a plurality of PSFCH occasions, and the determining unit 810 is further configured to determine a second parameter, wherein the second parameter is used to indicate a number of PSFCH occasions that are not used before a current time within a first time period; and the transmitting unit 820 is further configured to transmit sidelink channels or reference information other than the PSFCHs on remaining PSFCH occasions within the first time period in a case where the second parameter is greater than a second threshold.

In some embodiments, the PSFCH resources include a plurality of candidate PSFCH occasions, and the determining unit 810 is further configured to determine, based on second information, whether the plurality of candidate PSFCH occasions are valid.

In some embodiments, the second information includes a first bitmap, wherein the first bitmap is determined based on mapping relationships between the plurality of candidate PSFCH occasions and a plurality of subsets of PRBs, and the first bitmap includes a first sub-bitmap and a second sub-bitmap, each bit in the first sub-bitmap corresponding to a time unit, and each bit in the second sub-bitmap corresponding to a resource block within a unit frequency band.

In some embodiments, the number of bits in the second sub-bitmap is determined based on a subcarrier spacing and/or the unit frequency band.

In some embodiments, the second information further includes a second bitmap indicating whether the plurality of candidate PSFCH occasions are valid at different time-domain positions, wherein the second bitmap includes a first sub-bitmap and a second sub-bitmap, and a third sub-bitmap, each bit in the third sub-bitmap corresponding to a time unit.

In some embodiments, the second bitmap is configured to determine a third parameter, wherein the third parameter is used to indicate whether any of N subsets of PRBs is used, and the third parameter is determined based on a bitmap matrix M and indices of the N subsets of PRBs, an x^{th} subset of PRBs in the N subsets of PRBs having an index of PRB #x, and the x^{th} subset of PRBs having a third parameter of M[i][j][t]>[PRB #x], wherein N is a positive integer, 1≤x<N, i represents a time unit, j represents a unit frequency band, t represents a t^{th} time unit in T time units where the N subsets of PRBs are located, and t=1, 2, . . . , T.

In some embodiments, the second bitmap is configured to determine a fourth parameter, wherein the fourth parameter is used to indicate a number of subsets of PRBs that are not used in the PSFCH resources, and the fourth parameter is represented by a matrix C, wherein the matrix C is determined based on an initial bitmap matrix M₀ and an actual bitmap matrix M′ₜ following a t^{th} time unit, and the matrix C is represented as:

$$C = T \times {M}_{0} - {\sum }_{t = 1}^{T} {M}_{t}^{′} ;$$

wherein T represents the number of time units in the time domain of the PSFCH resources, and t=1, 2, . . . , T.

FIG. 9 is a schematic structural diagram of a communication apparatus 900 according to some embodiments of the present disclosure. The dotted lines in FIG. 9 indicate that the unit or module is optional. The communication apparatus 900 may be employed to perform the method according to the above method embodiments. The communication apparatus 900 may be a chip or a terminal device.

The communication apparatus 900 may include one or more processors 910. The communication processor 910 may support implementation of the method according to the above method embodiments by the communication apparatus 900. The processor 910 may be a general purpose processor or an application-specific processor. For example, the processor may be a central processing unit (CPU). The processor may be a general processor, a digital signal processor (DSP), an application specific integrated circuit (ASIC), a field programmable gate array (FPGA) or another programmable logic device, a discrete gate or transistor logic device, or a discrete hardware component, or the like. The general-purpose processor may be a microprocessor or any customary processor or the like.

The communication apparatus 900 may further include one or more memories 920. The memory 920 has stored thereon a program that is executable by the processor 910 to cause the processor 910 to perform the method described in the above method embodiments. The memory 920 may be separate from the processor 910 or integrated within the processor 910.

The communication apparatus 900 may also include a transceiver 930. The processor 910 may communicate with other devices or chips by the transceiver 930. For example, the processor 910 may communicate (transmit and receive) data with other devices or chips by the transceiver 930.

Some embodiments of the present disclosure further provide a computer-readable storage medium configured to store one or more programs. The computer-readable storage medium may be applied to a terminal device or a network device according to the embodiments of the present disclosure, and the one or more programs cause a computer to perform the method performed by the terminal device or the network device according to the respective embodiments of the present disclosure.

Some embodiments of the present disclosure further provide a computer program product. The computer program product includes one or more programs. The computer program product may be applied to a terminal device or a network device according to the embodiments of the present disclosure, and the one or more programs cause a computer to perform the method performed by the terminal device or the network device according to the respective embodiments of the present disclosure.

Some embodiments of the present disclosure further provide a computer program. The computer program may be applied to a terminal device or a network device according to the embodiments of the present disclosure, and the program causes a computer to perform the method performed by the terminal device or the network device according to the respective embodiments of the present disclosure.

It should be understood that in the present disclosure, the terms “system” and “network” in the specification are generally exchanged. Further, the terms used herein are for the purpose of describing particular embodiments only and are not intended to limit the present disclosure. The terms such as “first,” “second,” “third,” “fourth,” and the like in the specifications, claims and the accompanying drawings of the present disclosure are intended to distinguishing different objects but are not intended to define a specific sequence. In addition, terms “comprise,” “include,” and variations thereof are intended to define a non-exclusive meaning.

In the embodiments of the present disclosure, the term “indication” mentioned in the specification may indicate a direct indication, an indirect indication, or an association. By way of example, the expression “A indicates B” may mean that A directly indicates B, e.g., B may be obtained by A; or mean that A indicates B indirectly, for example A indicates C, and B may be obtained by C; or mean that an association is present between A and B.

In the embodiments of the present disclosure, the term “correspond” or derivatives thereof may mean that there is a direct correspondence or an indirect correspondence between the two, that there is a correlation between the two, and that there is a relationship between indicating and being indicated, configuring and being configured, or the like.

In embodiments of the present disclosure, “pre-defined” or “pre-configured” may be implemented by pre-storing a corresponding code, table, or other means that may be used to indicate relevant information in a device (e.g., including a terminal device and a network device), and the present disclosure does not limit the specific implementation thereof. For example, the term “predefined” may refer to “defined in the protocol.”

In embodiments of the present disclosure, the term “protocol” may refer to a standard protocol in the field of communications, and may include, for example, the LTE protocol, the NR protocol, and related protocols used in future communication systems, without limitation.

However, it should also be understood that determining B from A does not mean determining B from A alone, and B may also be determined from A and/or other information.

In the description of the embodiments of the present disclosure, the term “and/or” is merely an association relationship for describing associated objects, which represents that there may exist three types of relationships, for example, A and/or B may represent three situations: only A exists, both A and B exist, and only B exists. In addition, the forward-slash symbol “/” generally represents an “or” relationship between associated objects before and after the symbol.

It should be understood that in various embodiments of the present disclosure, the sequence numbers of the above various processes or steps do not denote a preferred sequence of performing the processes or steps; and the sequence of performing the processes and steps should be determined according to the functions and internal logics thereof, which shall not cause any limitation to the implementation process of the embodiments of the present disclosure.

In the several embodiments provided in the present disclosure, it should be understood that the disclosed system, apparatus and method may be practiced in other manners. The above described device embodiments are merely illustrative. For example, the unit division is merely logical function division and may be other divisions in actual practice. For example, a plurality of units or components may be combined or integrated into another device, or some features may be ignored or not performed. Additionally, the displayed or discussed mutual couplings or direct couplings or communication connections may be implemented through some interfaces. The indirect couplings or communication connections between the devices or units may be implemented in electronic, mechanical or other forms.

The units which are described as separate components may be physically separated or may be not physically separated, and the components which are illustrated as units may be or may not be physical units, that is, the components may be located in the same position or may be distributed into a plurality of network units. Some of or all of the units may be selected according to actual needs to achieve the objectives of the solutions of the embodiments.

In addition, functional units in the embodiments of the present disclosure may be integrated into one processing unit, or each of the units may exist along physically, or two or more units may be integrated into one unit.

In the above embodiments, the technical solutions may be totally or partially practiced by software, hardware, firmware or any combination thereof. During practice by software, the technical solutions may be totally or partially implemented in the form of a computer program product. The computer program product includes one or a plurality of computer-executable instructions. The computer program instructions, when loaded and executed on a computer, may cause the computer to totally or partially perform the procedures or functions in the embodiments of the present disclosure. The computer may be a general computer, a dedicated computer, a computer network, or another programming device. The computer-executable instructions may be stored in a computer-readable storage medium, or transferred from one computer-readable storage medium to another. For example, the computer-executable instructions may be transmitted from one website, computer, server or data center to another in a wired fashion, for example, a coaxial cable, an optical fiber, a digital subscriber line (DSL) or a wireless fashion, for example, an infrared ray, a radio, a microwave or the like. The computer-readable storage medium may be any available medium that is accessible or a data storage device such as a server, a data center or the like integrated with one or a plurality of available media. The available medium may be a magnetic medium, for example, a floppy disk, a hard disk or a magnetic tape, an optical medium, for example, a digital versatile disc (DVD), or a semiconductor medium, for example, a solid state disk (SSD) or the like.

The above embodiments are used only for illustrating the present disclosure, but are not intended to limit the protection scope of the present disclosure. Various modifications and replacements readily derived by those skilled in the art within technical disclosure of the present disclosure shall fall within the protection scope of the present disclosure. Therefore, the protection scope of the present disclosure is subject to the appended claims.

What is claimed is:

1. A method for sidelink communication, the method comprising:
determining, by a first terminal device, channel occupancy time (COT) resources in shared spectrum, wherein the COT resources comprise physical sidelink feedback channel (PSFCH) resources for transmitting PSFCHs;
assigning, by the first terminal device, the PSFCH resources to a plurality of terminal devices sharing the COT resources based on a first set of PSFCHs to be transmitted, wherein the plurality of terminal devices comprise the first terminal device, wherein the PSFCH resources comprises a first PSFCH occasion for the first terminal device; and
when the first terminal device does not transmit a PSFCH on the first PSFCH occasion, determining, by the first terminal device based on first information, whether to transmit a sidelink channel or reference signal other than the PSFCH on a time-domain resource of the first PSFCH occasion, wherein the time-domain resource of the first PSFCH occasion is different from a frequency-domain of the first PSFCH occasion.

2. The method according to claim 1, wherein PSFCHs in the first set of PSFCHs are determined based on priorities of part or all of PSFCHs to be transmitted by the plurality of terminal devices.

3. The method according to claim 1, further comprising:
subsequent to determination of the COT resources, ranking, by the first terminal device based on priorities, part or all of PSFCHs to be transmitted by the plurality of terminal devices to determine the first set of PSFCHs; or
prior to determination of the COT resources, ranking, by the first terminal device based on priorities, part or all of PSFCHs to be transmitted by the plurality of terminal devices to determine the first set of PSFCHs.

4. The method according to claim 1, further comprising:
transmitting, by the first terminal device, resource coordination information to a second terminal device in the plurality of terminal devices; and
receiving, by the first terminal device, feedback information related to the resource coordination information, wherein the feedback information is carried in sidelink control information (SCI) and/or a PSFCH.

5. The method according to claim 1, wherein the method further comprises:
determining, by the first terminal device, whether to transmit a PSFCH on the first PSFCH occasion; and
in a case where the first terminal device does not transmit the PSFCH on the first PSFCH occasion, determining, by the first terminal device based on first information, whether to transmit a sidelink channel or a reference signal other than the PSFCH on the first PSFCH occasion or on a time-domain resource where the first PSFCH occasion is located.

6. The method according to claim 5, wherein the first information is carried in sidelink control information (SCI).

7. The method according to claim 5, wherein the first information is related to a plurality of service types of the plurality of terminal devices, and the first information is used to indicate a first service type group and a second service type group in the plurality of service types, wherein sidelink channels, other than the PSFCHs, corresponding to the first service type group share the PSFCH resources, and sidelink channels, other than the PSFCHs, corresponding to the second service type group do not share the PSFCH resources.

8. The method according to claim 7, wherein the first information is further used to indicate that terminal devices corresponding to the second service type group transmit reference signals on PSFCH resources on which the PSFCHs are not transmitted.

9. The method according to claim 1, wherein the PSFCH resources comprise a plurality of PSFCH occasions; and the method further comprises:
determining, by the first terminal device, a first parameter, wherein the first parameter is used to indicate a number of PSFCH occasions that are not used within a first time period; and
transmitting, by the first terminal device, sidelink channels or reference information other than the PSFCHs on PSFCH occasions within a second time period in a case where the first parameter is greater than a first threshold, wherein the second time period is a time period immediately following the first time period.

10. The method according to claim 1, wherein the PSFCH resources comprise a plurality of PSFCH occasions; and the method further comprises:
determining, by the first terminal device, a second parameter, wherein the second parameter is used to indicate a number of PSFCH occasions that are not used before a current time within a first time period; and
transmitting, by the first terminal device, sidelink channels or reference information other than the PSFCHs on remaining PSFCH occasions within the first time period in a case where the second parameter is greater than a second threshold.

11. The method according to claim 1, wherein the PSFCH resources comprise a plurality of candidate PSFCH occasions; and the method further comprises:
determining, by the first terminal device based on second information, whether the plurality of candidate PSFCH occasions are valid.

12. The method according to claim 11, wherein the second information comprises a first bitmap, wherein the first bitmap is determined based on mapping relationships between the plurality of candidate PSFCH occasions and a plurality of subsets of physical resource blocks (PRBs), and the first bitmap comprises a first sub-bitmap and a second sub-bitmap, each bit in the first sub-bitmap corresponding to a time unit, and each bit in the second sub-bitmap corresponding to a resource block within a unit frequency band.

13. The method according to claim 12, wherein a number of bits in the second sub-bitmap is determined based on a subcarrier spacing and/or the unit frequency band.

14. The method according to claim 11, wherein the second information further comprises a second bitmap indicating whether the plurality of candidate PSFCH occasions are valid at different time-domain positions, wherein the second bitmap comprises a first sub-bitmap and a second sub-bitmap, and a third sub-bitmap, each bit in the third sub-bitmap corresponding to a time unit.

15. The method according to claim 14, wherein the second bitmap is configured to determine a third parameter, wherein the third parameter is used to indicate whether any of N subsets of physical resource blocks (PRBs) is used, and the third parameter is determined based on a bitmap matrix M and indices of the N subsets of PRBs, an x^{th} subset of PRBs in the N subsets of PRBs having an index of PRB #x, and the x^{th} subset of PRBs having a third parameter of M[i][j][t]>[PRB #x], wherein N is a positive integer, 1≤x<N, i represents a time unit, j represents a unit frequency band, t represents a t^{th} time unit in T time units where the N subsets of PRBs are located, and t=1, 2, . . . , T.

16. The method according to claim 14, wherein the second bitmap is configured to determine a fourth parameter, wherein the fourth parameter is used to indicate a number of subsets of physical resource blocks (PRBs) that are not used in the PSFCH resources, and the fourth parameter is represented by a matrix C, wherein the matrix C is determined based on an initial bitmap matrix M₀ and an actual bitmap matrix M₀ following a t^{th} time unit, and the matrix C is represented as:
$$C = T \times {M}_{0} - {\sum }_{t = 1}^{T} {M}_{t}^{′} ;$$
wherein T represents a number of time units in a time domain where the PSFCH resources are located, and t=1, 2, . . . , T.

17. A communication apparatus, comprising: a memory and a processor, wherein the memory is configured to store one or more programs, and the processor, is configured to call the one or more programs stored in the memory to perform operations comprising:
determining channel occupancy time (COT) resources in shared spectrum, wherein the COT resources comprise physical sidelink feedback channel (PSFCH) resources for transmitting PSFCHs;
assigning the PSFCH resources to a plurality of terminal devices sharing the COT resources based on a first set of PSFCHs to be transmitted, wherein the plurality of terminal devices comprise the communication apparatus, wherein the PSFCH resources comprises a first PSFCH occasion for the communication apparatus; and
when the communication apparatus does not transmit a PSFCH on the first PSFCH occasion, determining, based on first information, whether to transmit a sidelink channel or reference signal other than the PSFCH on a time-domain resource of the first PSFCH occasion, wherein the time-domain resource of the first PSFCH occasion is different from a frequency-domain of the first PSFCH occasion.

18. A computer-readable storage medium storing one or more programs therein, wherein the one or more programs, when loaded and run by a computer, causes the computer to perform operations comprising:
determining channel occupancy time (COT) resources in shared spectrum, wherein the COT resources comprise physical sidelink feedback channel (PSFCH) resources for transmitting PSFCHs;
assigning the PSFCH resources to a plurality of terminal devices sharing the COT resources based on a first set of PSFCHs to be transmitted, wherein the plurality of terminal devices comprise a first terminal device, wherein the PSFCH resources comprises a first PSFCH occasion for the first terminal device; and
when the first terminal device does not transmit a PSFCH on the first PSFCH occasion, determining, based on first information, whether to transmit a sidelink channel or reference signal other than the PSFCH on a time-domain resource of the first PSFCH occasion, wherein the time-domain resource of the first PSFCH occasion is different from a frequency-domain of the first PSFCH occasion.
